(19) United States
(12) Patent Application Publication
(10) Pub. No.: US 2009/0022403 A1
(43) Pub. Date: Jan. 22, 2009

(54) IMAGE PROCESSING APPARATUS, IMAGE PROCESSING METHOD, AND COMPUTER READABLE MEDIUM

(75) Inventors: Tetsuya TAKAMORI, Ashigarakami-gun (JP); Hirokazu Kameyama, Ashigarakami-gun (JP); Yukinori Noguchi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/175,876

(22) Filed: Jul. 18, 2008

(30) Foreign Application Priority Data
Jul. 20, 2007 (JP) 2007-190150
Jul. 3, 2008 (JP) 2008-174857

(51) Int. Cl. G06K 9/46

(52) U.S. Cl. 382/195

(57) ABSTRACT

There is provided an image processing apparatus for processing a moving image including a plurality of moving-image-component images. The image processing apparatus includes a characteristic region detecting section that detects a characteristic region in one or more of the plurality of moving-image-component images, and a characteristic region identifying section that identifies a position of the characteristic region in a non-selected image with reference to a position of the characteristic region in a selected image. Here, the selected image is selected from the plurality of moving-image-component images of the moving image, and the non-selected image is a different one of the plurality of moving-image-component images than the selected image. The characteristic region identifying section identifies the position of the characteristic region in the non-selected image with reference to a position of the characteristic region in a selected image preceding the non-selected image and a position of the characteristic region in a selected image following the non-selected image.

### CROSS REFERENCE TO RELATED APPLICATION

The present application claims priority from Japanese Patent Applications No. 2007-190150 filed on Jul. 20, 2007 and No. 2008-174857 filed on Jul. 3, 2008, the contents of which are incorporated herein by reference. The present application relates to Japanese Patent Applications No. 2008-078636 filed on Mar. 25, 2008, No. 2008-078641 filed on Mar. 25, 2008, No. 2008-091562 filed on Mar. 31, 2008, and No. 2008-098600 filed on Apr. 4, 2008, the contents of which are incorporated herein by reference.

### BACKGROUND

1. Technical Field

The present invention relates to an image processing apparatus, an image processing method and a computer readable medium. More particularly, the present invention relates to an image processing apparatus and an image processing method for compressing images, and a computer readable medium storing a program for use with the image processing apparatus.

2. Related Art

When coding image blocks showing a face detected in a moving image, a known image coding apparatus assigns more information bits to an image block containing eyes, a mouth or the like than to a different image block, for example, as disclosed in Japanese Patent No. 2828977.

According to the technique disclosed in Japanese Patent No. 2828977, the image coding apparatus detects image blocks showing the face, eyes, mouth or the like in each frame. Therefore, the image coding apparatus may require a long time period for the detection of the image blocks showing the face, eyes, mouth or the like.

### SUMMARY

Therefore, it is an object of an aspect of the innovations herein to provide an image processing apparatus, an image processing method, and a computer readable medium which are capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary image processing apparatus may include an image processing apparatus for processing a moving image including a plurality of moving-image-component images. The image processing apparatus includes a characteristic region detecting section that detects a characteristic region in one or more of the plurality of moving-image-component images, and a characteristic region identifying section that identifies a position of the characteristic region in a non-selected image with reference to a position of the characteristic region in a selected image. Here, the selected image is selected from the plurality of moving-image-component images of the moving image, and the non-selected image is a different one of the plurality of moving-image-component images than the selected image.

According to the second aspect related to the innovations herein, one exemplary image processing method may include an image processing method for processing a moving image including a plurality of moving-image-component images. The image processing method includes detecting a characteristic region in one or more of the plurality of moving-image-component images, and identifying a position of the characteristic region in a non-selected image with reference to a position of the characteristic region in a selected image. Here, the selected image is selected from the plurality of moving-image-component images of the moving image, and the non-selected image is a different one of the plurality of moving-image-component images than the selected image.

According to the third aspect related to the innovations herein, one exemplary computer readable medium may include a computer readable medium storing thereon a program for use with an image processing apparatus for processing a moving image including a plurality of moving-image-component images. The program causes the image processing apparatus to function as a characteristic region detecting section that detects a characteristic region in one or more of the plurality of moving-image-component images, and a characteristic region identifying section that identifies a position of the characteristic region in a non-selected image with reference to a position of the characteristic region in a selected image. Here, the selected image is selected from the plurality of moving-image-component images of the moving image, and the non-selected image is a different one of the plurality of moving-image-component images than the selected image.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an example of an image processing system 10 relating to an embodiment of the present invention.

FIG. 2A illustrates an exemplary block configuration of an image processing apparatus 120.

FIG. 2B illustrates an exemplary block configuration of an image processing apparatus 120.

FIG. 3 illustrates an exemplary block configuration of an image processing apparatus 170.

FIG. 4 illustrates an exemplary flow of the operations performed by the image processing apparatus 120.

FIG. 5 shows, as an example, the image qualities of characteristic region moving images and the image quality of a background region moving image.

FIG. 6 illustrates an exemplary flow of the operations performed by the image processing apparatus 170.

FIG. 7 illustrates an exemplary method for identifying a characteristic region in a plurality of moving-image-component images.

FIG. 8 illustrates an exemplary method to set, at a fixed value, the values of a region other than an inclusion region.

FIG. 9 illustrates an exemplary correlation between moving-image-component images.

FIG. 10A illustrates, as an example, characteristic regions which are correlated to each other.

FIG. 10B illustrates, as an example, characteristic regions which are correlated to each other.

FIG. 11 illustrates, as an example, a characteristic region in a moving-image-component image 910-6.

FIG. 12 illustrates characteristic regions distinguished from each other, as an example.

FIG. 13 illustrates another exemplary block configuration of the image processing apparatus 120.

FIG. 14A illustrates exemplary block configurations of inter-grade difference compressing sections 282a and 282b.

FIG. 14B illustrates exemplary block configurations of a movement analyzing section 285a and a difference processing section 287a.

FIG. 14C illustrates exemplary block configurations of a movement analyzing section 285b and a difference processing section 287b.

FIG. 15 illustrates an exemplary configuration of an image processing system 20 relating to a different embodiment.

FIG. 16 illustrates an exemplary hardware configuration of the image processing apparatuses 120 and 170.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

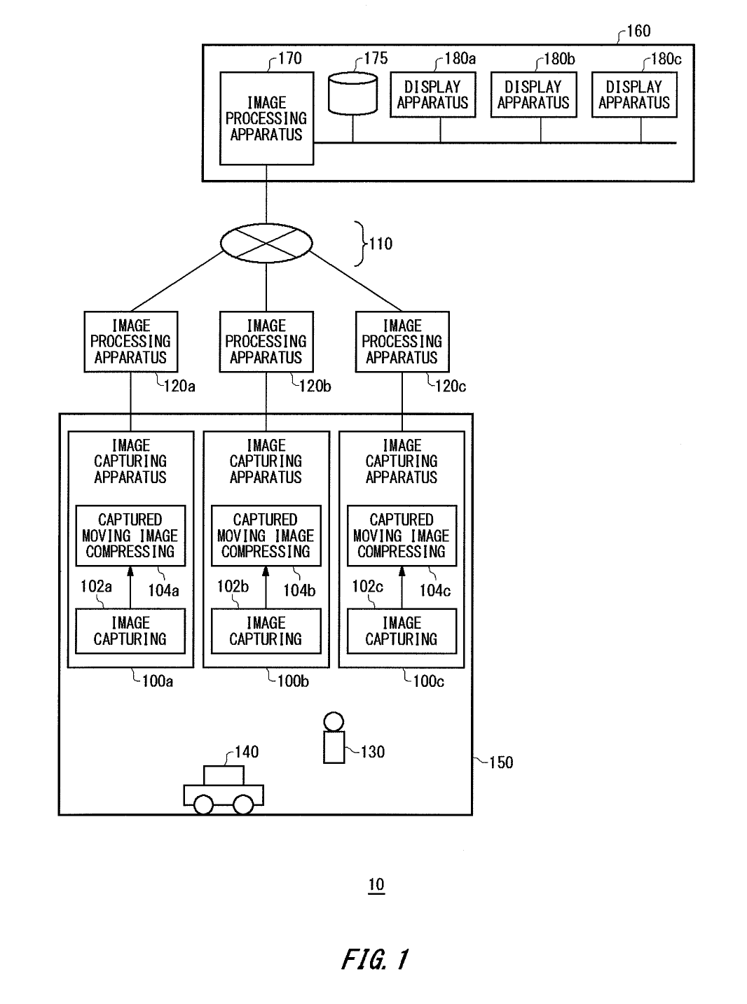

FIG. 1 illustrates an example of an image processing system 10 relating to an embodiment of the present invention. The image processing system 10 is designed to maintain high quality of the image of a characteristic subject with it being possible to reduce the data amount of the entire image.

The image processing system 10 includes a plurality of image capturing apparatuses 100a to 100c (hereinafter collectively referred to as the image capturing apparatus 100) that capture images of a monitored space 150, a plurality of image processing apparatuses 120a to 120c (hereinafter collectively referred to as the image processing apparatus 120) that process the images, an image processing apparatus 170, a communication network 110, an image database 175, and a plurality of display apparatuses 180a to 180c (hereinafter collectively referred to as the display apparatus 180).

The image processing apparatus 120a is connected to the image capturing apparatus 100a. The image processing apparatus 120b is connected to the image capturing apparatus 100b. The image processing apparatus 120c is connected to the image capturing apparatus 100c. The image processing apparatus 170 and the display apparatus 180 are provided within a space 160 which is different from the monitored space 150.

The following describes the operations of the image capturing apparatus 100a, the image processing apparatus 120a, the image processing apparatus 170, and the display apparatus 180a. The image capturing apparatus 100a captures an image of the monitored space 150, MPEG-codes the captured moving image to generate captured moving image data, and outputs the generated captured moving image data to the image processing apparatus 120a to which the image capturing apparatus 100a is connected.

Here, the image capturing apparatus 100a includes an image capturing section 102a and a captured moving image compressing section 104a. The image capturing section 102a image-captures the monitored space 150, to generate a plurality of moving-image-component images that are included in a captured moving image. The image capturing section 102a may generate moving-image-component images in the RAW format. The captured moving image compressing section 104a performs color estimation (coinciding) processing on the moving-image-component images in the RAW format generated by the image capturing section 102a to obtain a captured moving image including a plurality of moving-image-component images, and compresses the captured moving image by using such a technique as the MPEG coding. In this manner, the captured moving image compressing section 104a generates the captured moving image data.

The image processing apparatus 120a obtains the captured moving image data generated by the image capturing apparatus 100a. The image processing apparatus 120a decodes the captured moving image data obtained from the image capturing apparatus 100a to generate the captured moving image, and detects a plurality of characteristic regions in the generated captured moving image. Here, the characteristic regions contain different types of characters including a person 130 and a moving article 140 such as a vehicle. Based on the captured moving image, the image processing apparatus 120a generates a plurality of characteristic region moving images in a one-to-one correspondence with the characters of different types. In each characteristic region moving image, a corresponding one of the characteristic regions has a higher image quality than the remaining region. The image processing apparatus 120a also generates a background region moving image that is a moving image of a background region of the captured moving image excluding the characteristic regions. The background region moving image has a lower image quality than the characteristic region moving images.

The image processing apparatus 120a respectively codes the characteristic region moving images and the background region moving image, to generate a plurality of pieces of characteristic region moving image data and a piece of background region moving image data. At the same time, the image processing apparatus 120a associates the pieces of characteristic region moving image data and the piece of background region moving image data with each other, and transmits the pieces of characteristic region moving image data and the piece of background region moving image data which are associated with each other, to the image processing apparatus 170 via the communication network 110.

The image processing apparatus 170 respectively decodes the pieces of characteristic region moving image data and the piece of background region moving image data, which are associated with each other and received from the image processing apparatus 120a, to obtain a plurality of characteristic region moving images and a background region moving image. The image processing apparatus 170 combines the characteristic region moving images and the background region moving image to generate a single combined moving image, and provides the combined moving image to the display apparatus 180a. The display apparatus 180a displays the moving image provided from the image processing apparatus 170.

The image processing apparatus 170 may record the combined moving image or the captured moving image data obtained from the image processing apparatus 120a onto the image database 175. The image processing apparatus 170 may supply the combined moving image which is recorded on the image database 175 to the display apparatus 180a in response to a request issued by the display apparatus 180a. The image processing apparatus 170 may decode, as mentioned above, the captured moving image data which is recorded on the image database 175 and supply the resulting moving image to the display apparatus 180a, in response to a request issued by the display apparatus 180a. The image database 175 may have a non-volatile recording medium such as a hard disk, and record the combined moving image supplied from the image processing apparatus 170 on the recording medium.

The image capturing apparatuses 100b and 100c respectively include constituents having the same functions as the constituents of the image capturing apparatus 100a. The image capturing apparatuses 100b and 100c have the same functions and operations as the image capturing apparatus 100a, except that the image capturing apparatuses 100b and 100c respectively supply the captured moving image data to the image processing apparatuses 120b and 120c. Hence, the image capturing apparatuses 100b and 100c are not explained herein. The image processing apparatuses 120b and 120c may have the same functions and operations as the image processing apparatus 120a, except that the image processing apparatuses 120b and 120c respectively obtain the captured moving image data from the image capturing apparatuses 100b and 100c. Hence, the image processing apparatuses 120b and 120c are not explained herein. Note that the following description may refer to the image capturing sections 102a to 102c as the image capturing section 102 and may refer to the captured moving image compressing sections 104a to 104c as the captured moving image compressing section 104.

The image processing apparatus 170 generates a single moving image based on a plurality of pieces of characteristic region moving image data and a piece of background region moving image data which are associated with each other and received from each of the image processing apparatuses 120b and 120c, and supplies the single moving image to a corresponding one of the display apparatuses 180b and 180c. The display apparatuses 180b and 180c respectively display the moving images supplied from the image processing apparatus 170.

When utilized as a monitoring system, for example, the image processing system 10 relating to the present embodiment may be capable of keeping high-quality images of a person, a moving article, and other characteristic subjects to be monitored. In addition, the image processing system 10 relating to the present embodiment may be capable of reducing the data amount of the moving images.

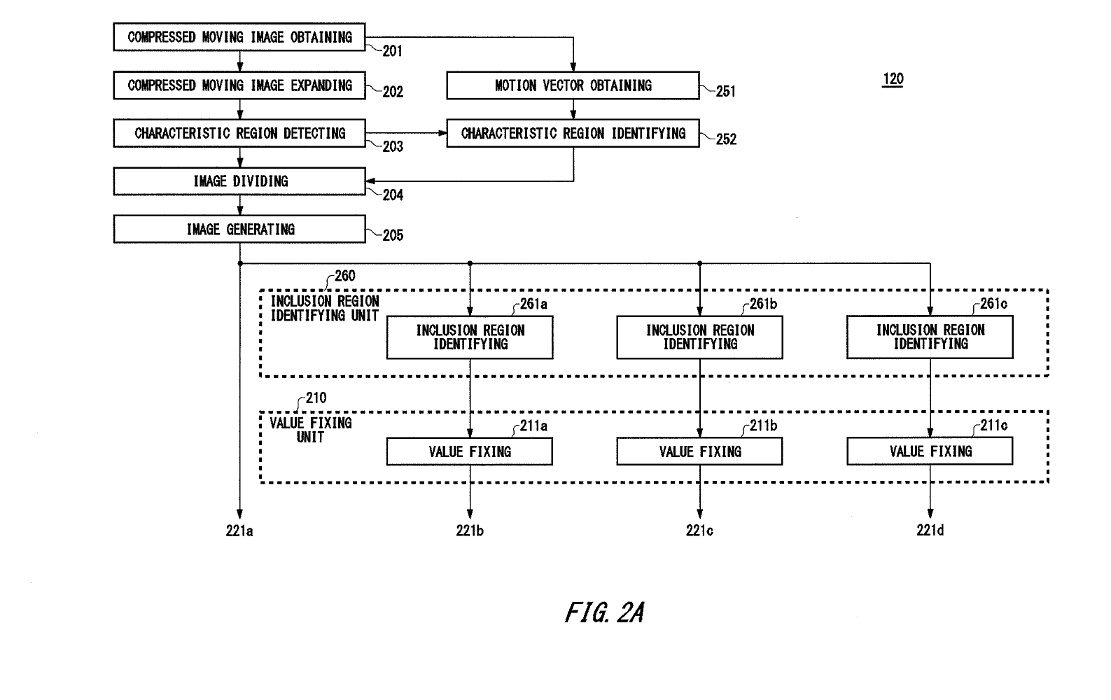

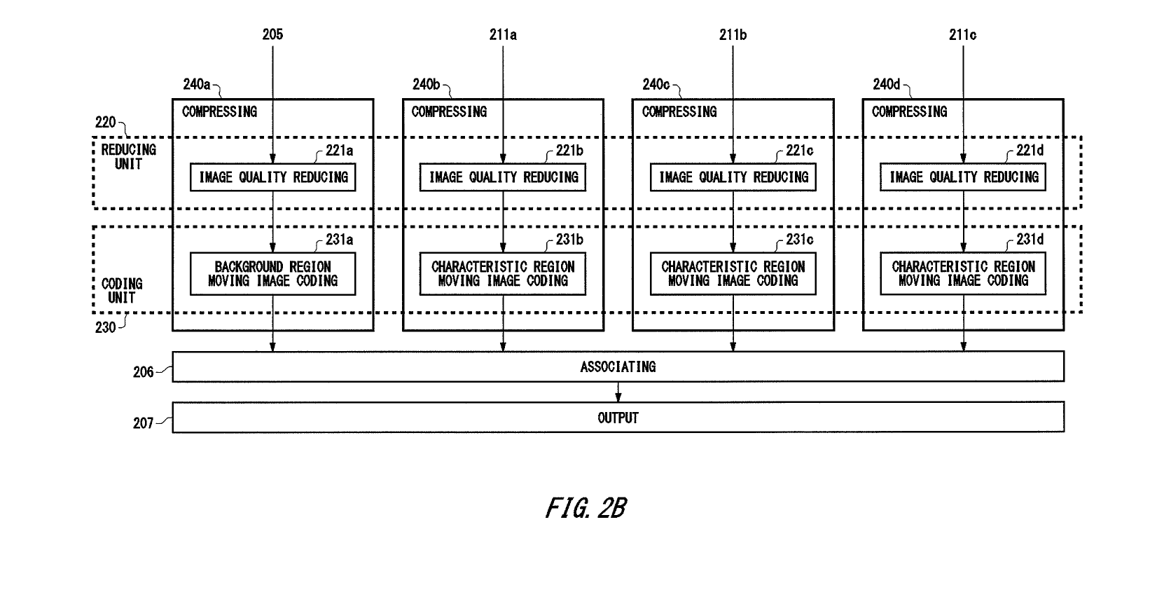

FIGS. 2A and 2B illustrate an exemplary block configuration of the image processing apparatus 120. The image processing apparatus 120 includes a compressed moving image obtaining section 201, a compressed moving image expanding section 202, a characteristic region detecting section 203, an image dividing section 204, and an image generating section 205. The image processing apparatus 120 further includes a motion vector obtaining section 251, a characteristic region identifying section 252, an inclusion region identifying unit 260, a value fixing unit 210, a reducing unit 220, a coding unit 230, an associating section 206, and an output section 207.

The inclusion region identifying unit 260 includes a plurality of inclusion region identifying sections 261a to 261c (hereinafter collectively referred to as the inclusion region identifying section 261). The value fixing unit 210 includes a plurality of value fixing sections 211a to 211c (hereinafter collectively referred to as the value fixing section 211). The reducing unit 220 includes a plurality of image quality reducing sections 221a to 221d (hereinafter collectively referred to as the image quality reducing section 221).

The coding unit 230 includes a background region moving image coding section 231a and a plurality of characteristic region moving image coding sections 231b to 231d (hereinafter collectively referred to as the characteristic region moving image coding section 231). Here, the background region moving image coding section 231a and the characteristic region moving image coding sections 231b to 231d may be collectively referred to as the coding section 231.

The image quality reducing section 221a and the background region moving image coding section 231a together function as a compressing section 240a. The image quality reducing section 221b and the characteristic region moving image coding section 231b together function as a compressing section 240b. The image quality reducing section 221c and the characteristic region moving image coding section 231c together function as a compressing section 240c. The image quality reducing section 221d and the characteristic region moving image coding section 231d together function as a compressing section 240d. These compressing sections 240a to 240d are collectively referred to as the compressing section 240.

The compressed moving image obtaining section 201 obtains a compressed moving image. Specifically speaking, the compressed moving image obtaining section 201 obtains the captured moving image data which is generated by the image capturing apparatus 100. For example, the compressed moving image obtaining section 201 obtains an MPEG moving image including a motion vector. The compressed moving image expanding section 202 decompresses the moving image obtained by the compressed moving image obtaining section 201, to generate the moving-image-component images included in the moving image.

Specifically speaking, the compressed moving image expanding section 202 decodes the captured moving image data obtained by the compressed moving image obtaining section 201, to generate the moving-image-component images included in the moving image. For example, the compressed moving image expanding section 202 expands the MPEG moving image obtained by the compressed moving image obtaining section 201. The moving-image-component images may be frame images, field images or the like. The compressed moving image includes a motion vector associated with a subject of the moving image.

The characteristic region detecting section 203 detects characteristic regions in the moving-image-component images included in the moving image. Specifically speaking, the characteristic region detecting section 203 detects a plurality of characteristic regions with different types of characters in the moving-image-component images included in the moving image. More specifically, the characteristic region detecting section 203 selects moving-image-component images at given intervals or at time intervals calculated based on what is shown by the moving image, from the moving image generated as a result of the expansion by the compressed moving image expanding section 202, and detects the characteristic regions in selected images which are the selected moving-image-component images. For example, the characteristic region detecting section 203 selects I frames from the MPEG moving image generated as a result of the expansion by the compressed moving image expanding section 202, and detects the characteristic regions in each of the selected I frames. The characteristic region detecting section 203 may select moving-image-component images as the selected images at intervals adjusted in accordance with the speed of a moving article in the moving image or the change in the scene luminance of the moving image.

The motion vector obtaining section 251 obtains a motion vector of a subject in a moving image. Specifically speaking, the motion vector obtaining section 251 obtains a motion vector included in a moving image obtained by the compressed moving image obtaining section 201 (the captured moving image data). More specifically, the motion vector obtaining section 251 obtains a motion vector included in the MPEG moving image obtained by the compressed moving image obtaining section 201. When the motion vector obtaining section 251 can obtain no motion vector from the moving image obtained by the compressed moving image obtaining section 201, the motion vector obtaining section 251 may calculate a motion vector for the moving image generated as a result of the expansion by the compressed moving image expanding section 202, based on the moving-image-component images included in the moving image.

The characteristic region identifying section 252 refers to the positions of the characteristic regions in the selected images to identify the positions of the characteristic regions in non-selected image, where the selected images are the moving-image-component images which are selected from the moving image and the non-selected images are the moving-image-component images which are not selected from the moving image. Specifically speaking, the characteristic region identifying section 252 identifies the positions of the characteristic regions in the non-selected images, based on the positions of the characteristic regions in the selected images preceding and following the non-selected images in the time axis.

More specifically, the characteristic region identifying section 252 identifies the positions of the characteristic regions in the non-selected images based on the positions of the characteristic regions in the selected images preceding and following the non-selected images in the time axis and the motion vectors obtained by the motion vector obtaining section 251. For example, the characteristic region identifying section 252 identifies the positions of the characteristic regions in P or B frames, which are the non-selected images, based on the positions of the characteristic regions in I frames, which are the selected images, preceding and following in the time axis the P or B frames, which are the non-selected images, and the motion vectors obtained by the motion vector obtaining section 251.

The characteristic region identifying section 252 may identify the positions of the characteristic regions in the non-selected images, based on the positions of the characteristic regions in one or more selected images preceding the non-selected images in the time axis and the motion vectors obtained by the motion vector obtaining section 251. Alternatively, the characteristic region identifying section 252 may identify the positions of the characteristic regions in the non-selected images, based on the positions of the characteristic regions in one or more selected images following the non-selected images in the time axis and the motion vectors obtained by the motion vector obtaining section 251.

The characteristic region identifying section 252 may identify the positions of the characteristic regions in the non-selected images based on the positions of the characteristic regions in the selected images preceding and following the non-selected images in the time axis, by using the linear interpolation technique. The characteristic region identifying section 252 may identify the positions of the characteristic regions in the non-selected images based on the positions of the characteristic regions in one or more selected images preceding the non-selected images in the time axis, by using the linear interpolation technique. The characteristic region identifying section 252 may identify the positions of the characteristic regions in the non-selected images based on the positions of the characteristic regions in one or more selected images following the non-selected images in the time axis, by using the linear interpolation technique.

The image dividing section 204 divides each of the moving-image-component images into a characteristic region and a background region. Specifically speaking, the image dividing section 204 divides each of the moving-image-component images into a plurality of characteristic regions and a background region other than the characteristic regions.

The image generating section 205 generates a characteristic region compression moving image used for generating a characteristic region moving image and a background region compression moving image used for generating a background region moving image. Specifically speaking, the image generating section 205 extracts characteristic region images from moving-image-component images included in a moving image, and duplicates the extracted characteristic region images, to generate a characteristic region compression moving image. More specifically, the image generating section 205 extracts characteristic region images of a plurality of types from moving-image-component images included in a moving image, to generate a plurality of characteristic region compression moving images. The image generating section 205 extracts background region images from moving-image-component images included in a moving image, and duplicates the extracted background region images, to generate a background region compression moving image.

The inclusion region identifying section 261 identifies an inclusion region including a plurality of characteristic regions in each of the characteristic region compression moving images. Specifically speaking, the inclusion region identifying section 261 identifies, as an inclusion region, a group of macroblocks including a plurality of characteristic regions in each of the characteristic region compression moving images.

The value fixing section 211 sets, at a fixed value, the pixel values of a region other than the inclusion region identified by the inclusion region identifying section 261 in the moving-image-component images included in each of the characteristic region compression moving images. For example, the value fixing section 211 sets, at a predetermined value, the pixel values of the region other than the inclusion region (for example, sets the luminance values at zero).

The compressing section 240 then compresses each of the characteristic region compression moving images, which includes the moving-image-component images in which the pixel values of the region other than the inclusion region are set at the fixed value, at the strength determined according to the characteristic amount of the characteristic region compression moving image. The compressing section 240 also codes the image of the inclusion region and the image of the region other than the inclusion region at different strengths in each of the characteristic region compression moving images.

As described, the compressing section 240 individually compresses the characteristic region compression moving images and the background region compression moving image, at the strengths determined according to the characteristic amounts of the compression moving images. Here, the characteristic amount herein indicates any one of the type of the subject, the size of the subject, the moving speed of the moving article, and the size of the characteristic region.

As explained in the above, the characteristic region detecting section 203 detects the characteristic regions in the images. The image dividing section 204 divides each image into the characteristic regions and the background region other than the characteristic regions. The compressing section 240 compresses the characteristic region images showing the characteristic regions and the background region image showing the background region, individually at different strengths. The compressing section 240 compresses the characteristic region moving images each including a plurality of characteristic region images and the background region moving image including a plurality of background region images, respectively at different strengths.

Each of the compressing sections 240b, 240c and 240d is configured to compress a characteristic region moving image of a predetermined type. Each of the compressing sections 240b, 240c and 240d compresses a characteristic region moving image showing a character of a predetermined type. Here, the compression strengths at which the characteristic region moving images showing characters of different types are compressed are determined in advance in association with the types of the characters. Each of the compressing sections 240b, 240c and 240d compresses a characteristic region moving image showing a predetermined type of character at a predetermined compression strength associated with the predetermined type of character. In this manner, the compressing section 240 uses compressors provided in a one-to-one correspondence with the image regions defined by the image dividing section 204, so as to compress a plurality of regions in parallel.

The compressing section 240 may be implemented by a single compressor. In this case, the compressing section 240 may sequentially in time compress the characteristic region moving images and the background region moving image. Alternatively, the compressing section 240 may compress the captured moving image obtained by the decoding operation of the compressed moving image expanding section 202, by compressing the regions defined by the image dividing section 204 at the compression rates determined in advance for the character types and the background of the regions. In this manner, the compressing section 240 may generate a single piece of moving image data.

In the compressing section 240, the image quality reducing section 221 compresses the characteristic region moving images and the background region moving image by reducing their image qualities according to their respective characteristic amounts. In more details, the image quality reducing section 221 compresses the characteristic region moving images and the background region moving image by reducing the resolutions or frame rates according to their respective characteristic amounts.

In the compressing section 240, the coding section 231 compresses the characteristic region moving images and the background region moving image by coding the moving images with the use of values set according to their respective characteristic amounts. For example, the coding section 231 compresses the characteristic region moving images and the background region moving image by coding the moving images with the use of code amounts assigned according to their respective characteristic amounts.

The associating section 206 associates, with each other, a plurality of pieces of characteristic region moving image data and a piece of background region moving image data which are generated by the plurality of compressing sections 240 by compressing the characteristic region moving images and the background region moving image. This association is achieved, for example, by adding tag information. The output section 207 transmits the pieces of characteristic region moving image data and the piece of background region moving image data, which are associated with each other by the associating section 206, to the communication network 110.

The characteristic region detecting section 203 may detect a characteristic region by using the method disclosed in Japanese Patent Application No. 2008-078641. For example, the characteristic region detecting section 203 discards some of the pixels of a captured image in which an object is to be detected at a single predetermined rate or at predetermined rates. In this manner, the characteristic region detecting section 203 generates an image group composed of the captured image and one or more pixel-discarded images. The characteristic region detecting section 203 applies a first filter to a first image, to calculate an evaluation value. Here, the first image has a relatively small size among the images included in the generated image group, and the first filter acts on a two-dimensional region on the image and generates the evaluation value representing the likelihood that an object of a particular type is present within the region. The first filter may be selected from a group of filters which respectively act on regions of different sizes, and be designed to act on a relatively small region, where each filter has a predetermined number of pixels in accordance with the size of the region on the image. The characteristic region detecting section 203 extracts, from the first image, a primary candidate region which produces an evaluation value exceeding a predetermined first threshold value.

The characteristic region detecting section 203 then applies a second filter to a region corresponding to the primary candidate region in a second image to calculate an evaluation value, where the second image has more pixels by a predetermined number than the first image and the second filter is selected from the group of filters and designed to act on a larger region by a predetermined size than the first filter is. In this manner, the characteristic region detecting section 203 extracts a secondary candidate region which produces an evaluation value exceeding a predetermined second threshold value.

The characteristic region detecting section 203 applies the above-mentioned group of filters that are designed to act on regions of different sizes to the regions of corresponding sizes included in the group of images, to repeat the above-described extracting operation of extracting the candidate region. Here, the characteristic region detecting section 203 repeatedly performs the extracting operations in such a manner as to start from an extracting operation of applying a filter that is designed to act on a relatively small region and sequentially increase the size of the region on which the applied filter acts on. Specifically speaking, the characteristic region detecting section 203 repeatedly and sequentially performs the extracting operations in such a manner as to start with an extracting operation of applying a filter that is designed to act on a relatively small region to a relatively small image and to end with an extracting operation of applying a filter that is designed to act on a relatively large region to a relatively large image. The characteristic region detecting section 203 repeatedly performs two or more extracting operations, to extract a final candidate region. In this manner, the characteristic region detecting section 203 detects an object of a particular type. The characteristic region detecting section 203 then detects a region in which the particular type of object is present, as a characteristic region. As described above, the characteristic region detecting section 203 limits the application of the filters to a region that is extracted in an immediately preceding extracting operation. In other words, the respective extracting operations sequentially judge whether the object is present. As a result, the characteristic region detecting section 203 can accurately detect the characteristic regions. In addition, since the above-described method uses small images to roughly detect the characteristic region, the characteristic region detecting section 203 can detect the characteristic regions within a shorter time.

Alternatively, the characteristic region detecting section 203 may detect a characteristic region by using the method disclosed in Japanese Patent Application No. 2008-078636. For example, the characteristic region detecting section 203 detects a characteristic region by means of a plurality of filters, each of which is designed to act on a two-dimensional region having a predetermined size in the captured image and calculates one of the different characteristic amounts relating to the outline of and the area occupied by an object of a particular type. Specifically speaking, the characteristic region detecting section 203 applies those filters to a region having a predetermined size on the captured image in which the object is to be detected, to calculate a plurality of characteristic amounts. Here, each of the filters is associated with a relation between the characteristic amount calculated by the filter and a primary evaluation value representing the likelihood of the presence of the object of the particular type. The characteristic region detecting section 203 refers to such relations and obtains primary evaluation values related to the calculated characteristic amounts. The characteristic region detecting section 203 then integrates the primary evaluation values corresponding to the filters, to obtain a secondary evaluation value representing the likelihood that the object of the particular type is present in the region. The characteristic region detecting section 203 compares the secondary evaluation value with a threshold value in order to extract a region which produces a secondary evaluation value exceeding the threshold value and in which the object of the particular type is highly likely to be present. In the above-described manner, the characteristic region detecting section 203 detects the extracted region as a characteristic region in which the object of the particular type is present. As described above, the characteristic region detecting section 203 combines a plurality of filters that extract characteristic amounts relating to a variety of characters of the outline of and the area occupied by an object. Therefore, the characteristic region detecting section 203 can extract the characteristic regions more accurately when compared with a characteristic region detecting operation performed only with reference to, for example, the outline shape of an object.

The characteristic region detecting section 203 may combine the methods disclosed in Japanese Patent Application Nos. 2008-078636 and 2008-078641 in order to detect a characteristic region. Specifically speaking, the filters described above in relation to the method disclosed in Japanese Patent Application No. 2008-078636 may include a plurality of sets of filters, where each set of filters corresponds to a region of a particular size. The filters in each set have a predetermined number of pixels. Each filter may be associated with the above-mentioned relation between the characteristic amount and the primary evaluation value. The characteristic region detecting section 203 discards some of the pixels of a captured image in which objects are to be detected at a single predetermined rate, or at predetermined rates. In this manner, the characteristic region detecting section 203 generates an image group composed of the captured image and one or more pixel-discarded images. The characteristic region detecting section 203 applies a plurality of first filters to a first image, to calculate a plurality of characteristic amounts. Here, the first image has a relatively small size among the images included in the image group, and the first filters are designed to act on a relatively small region. Based on the relations respectively associated with the first filters, the characteristic region detecting section 203 obtains primary evaluation values corresponding to the calculated characteristic amounts. The characteristic region detecting section 203 then integrates the primary evaluation values to obtain a secondary evaluation value representing the likelihood that an object of a particular type is present in the region. The characteristic region detecting section 203 compares the obtained secondary evaluation value with a first threshold value, in order to extract a primary candidate region which produces a secondary evaluation value exceeding the first threshold value and in which the object of the particular type is highly likely to be present.

The characteristic region detecting section 203 applies a plurality of second filters to a region corresponding to the primary candidate region in a second image, to calculate a plurality of characteristic amounts. Here, the second image is included in the image group and has more pixels by a predetermined number than the first image, and the second filters are designed to act on a larger region by a predetermined size than the first filters are. Based on the relations associated with the second filters, the characteristic region detecting section 203 obtains primary evaluation values corresponding to the calculated characteristic amounts. The characteristic region detecting section 203 then integrates the primary evaluation values corresponding to the second filters, to obtain a secondary evaluation value representing the likelihood that the object of the particular type is present in the region corresponding to the primary candidate region. The characteristic region detecting section 203 compares the obtained secondary evaluation value with a second threshold value, in order to extract a secondary candidate region which produces a secondary evaluation value exceeding the second threshold value and in which the object of the particular type is highly likely to be present.

The characteristic region detecting section 203 repeatedly performs the extracting operations of extracting the candidate regions, by applying the above-mentioned plurality of sets of filters, where each set is designed to act on a region of a different size, to the regions of correspondingly different sizes in the image group. Here, the characteristic region detecting section 203 repeatedly performs the extracting operations in such a manner as to start from an extracting operation of applying filters that are designed to act on a relatively small region and sequentially increase the size of the region on which the applied filters act on. Specifically speaking, the characteristic region detecting section 203 repeatedly and sequentially performs the extracting operations in such a manner as to start with an extracting operation of applying filters that are designed to act on a relatively small region to a relatively small image and to end with an extracting operation of applying filters that are designed to act on a relatively large region to a relatively large image. The characteristic region detecting section 203 repeatedly performs two or more extracting operations, to extract a final candidate region. In this manner, the characteristic region detecting section 203 detects an object of a particular type. The characteristic region detecting section 203 detects a region in which the object of the particular type is present, as a characteristic region.

The characteristic region detecting section 203 may detect a characteristic region by using the method disclosed in Japanese Patent Application No. 2008-098600. For example, the characteristic region detecting section 203 detects a characteristic region from a plurality of captured images included in the moving images captured by a plurality of image capturing apparatuses 100. For example, it is assumed that the image capturing apparatuses 100a and 100b capture the images of the same scene. For example, the image capturing apparatuses 100a and 100b may serve as a stereo camera. In the following description, an image pair denotes a pair of a first captured image captured by the image capturing apparatus 100a and a second captured image captured by the image capturing apparatus 100b. The characteristic region detecting section 203 detects an object of a particular type in the image pair, and detects a region in which the detected object of the particular type is present as a characteristic region.

The characteristic region detecting section 203 extracts a region in which the object of the particular type is shown in each of the first and second captured images forming the image pair. Here, the characteristic region detecting section 203 may detect the region in which the object of the particular type is shown at a low accuracy. The characteristic region detecting section 203 then detects the object of the particular type by detecting a pair of corresponding regions from among the extracted regions on the first and second captured images. For example, the characteristic region detecting section 203 calculates the distance from the image capturing apparatuses 100a and 100b to the subject shown in the regions with reference to the images of the pair of regions. The characteristic region detecting section 203 uses the three-dimensional shape of the subject which is obtained based on the distance to the object, in order to detect the object of the particular type.

When detecting the pair of corresponding regions, the characteristic region detecting section 203 divides, into a plurality of sub-regions, each of the regions in which the object of the particular type is shown, which are detected from the first and second captured images forming the image pair. The characteristic region detecting section 203 calculates a characteristic amount characterizing a partial image in each sub-region, and then calculates a vector representing the characteristic amounts of the sub-regions. Here, the characteristic amount can be exemplified by pixel values, and the vector can be exemplified by a gradient vector (for example, a pixel value gradient vector). The characteristic region detecting section 203 calculates a logical distance between the calculated vector of the region on the first image and the calculated vector of the region on the second image. The characteristic region detecting section 203 detects, as the pair of corresponding regions, a pair of regions which have a shorter logical distance therebetween than a predetermined value. Here, the logical distance may be exemplified by a square-root of sums of squares of the differences between the components of the vectors. In the above manner, the characteristic region detecting section 203 can accurately extract the pair of corresponding regions from the image pair, thereby accurately calculating the distance to the subject. As a result, the characteristic region detecting section 203 can accurately recognize the three-dimensional shape of the subject, and thus can accurately detect the object of the particular type.

The characteristic region detecting section 203 may detect a characteristic region by using the method disclosed in Japanese Patent Application No. 2008-091562. For example, the characteristic region detecting section 203 extracts a subject-similar shape similar to a subject of a particular type from each of the captured images included in a moving image, along with the dimensions of the subject-similar shape and the position information of the subject-similar shape in the view angle of the image capturing apparatus 100. The position information in the view angle can be exemplified by the position in the image region within the captured image. The characteristic region detecting section 203 judges whether the extracted subject-similar shape represents the subject of the particular type, and then extracts the subject of the particular type. For example, the characteristic region detecting section 203 may count the number of subjects with the subject-similar shape which have the same dimensions as the extracted subject-similar shape in a predetermined search region including the subject with the subject-similar shape, and extract the subject with the subject-similar shape as the subject of the particular type when the counted number is more than or equal to a threshold value. The characteristic region detecting section 203 may detect, as a characteristic region, the region containing the subject of the particular type. In this manner, the characteristic region detecting section 203 can detect, as the subject of the particular type, a subject having a subject-similar shape that is present in the image region within which a large number of subjects having dimensions similar to predetermined dimensions are detected. Here, the characteristic region detecting section 203 can be prevented from detecting, as the subject of the particular type, a subject having the subject-similar shape that is present in a different region than this image region. As a result, the characteristic region detecting section 203 can be configured so as to be less likely to mistakenly detect, as the subject of the particular type, subjects having the subject-similar shape that are present in the different region than the above image region.

When the image capturing apparatus 100 has a variable view angle, the above-mentioned position information in the view angle may be exemplified by the direction in which the image capturing apparatus 100 faces when capturing images and the position on the captured image. When a plurality of image capturing apparatuses 100 can be used to capture images of a larger continuous field than when a single image capturing apparatus 100 is used, the above-mentioned position information in the view angle can be exemplified by the directions in which the respective image capturing apparatuses 100 face when capturing images and the positions on the captured images respectively captured by the image capturing apparatuses 100.

According to the configuration shown in FIGS. 2A and 2B, the compressing sections 240 included in the image processing apparatus 120 compress the characteristic region images and the background region image in a one-to-one correspondence. According to a different configuration, however, the image processing apparatus 120 may include a single compressing section 240, which may compress the characteristic region images and the background region image respectively at different strengths. For example, the characteristic region images and the background region image may be sequentially supplied to the single compressing section 240 in a time-sharing manner, and the single compressing section 240 may sequentially compress the characteristic region images and the background region image respectively at the different strengths.

Alternatively, the single compressing section 240 may compress the characteristic region images and the background region image respectively at different strengths by quantizing a plurality of pieces of image information of the characteristic regions and a piece of image information of the background region respectively with different quantization coefficients. Furthermore, the characteristic region images and the background region image may be converted into images with different image qualities, and the resulting images may be supplied to the single compressing section 240. The single compressing section 240 may respectively compress the supplied images which are obtained from the characteristic region images and the background region image.

In the above-mentioned embodiments where the single compressing section 240 quantizes the image of each region with a different quantization coefficient or compresses the image of each region having a different image quality, the single compressing section 240 may compress a single entire image or each of the partial regions of an image which are defined by the image dividing section 204 as described with reference to FIGS. 2A and 2B. When the single compressing section 240 compresses a single entire image, the image dividing operation by the image dividing section 204 and the value fixing operation by the value fixing section 211 are not necessary. Thus, the image processing apparatus 120 may be configured without the image dividing section 204 and the value fixing unit 210.

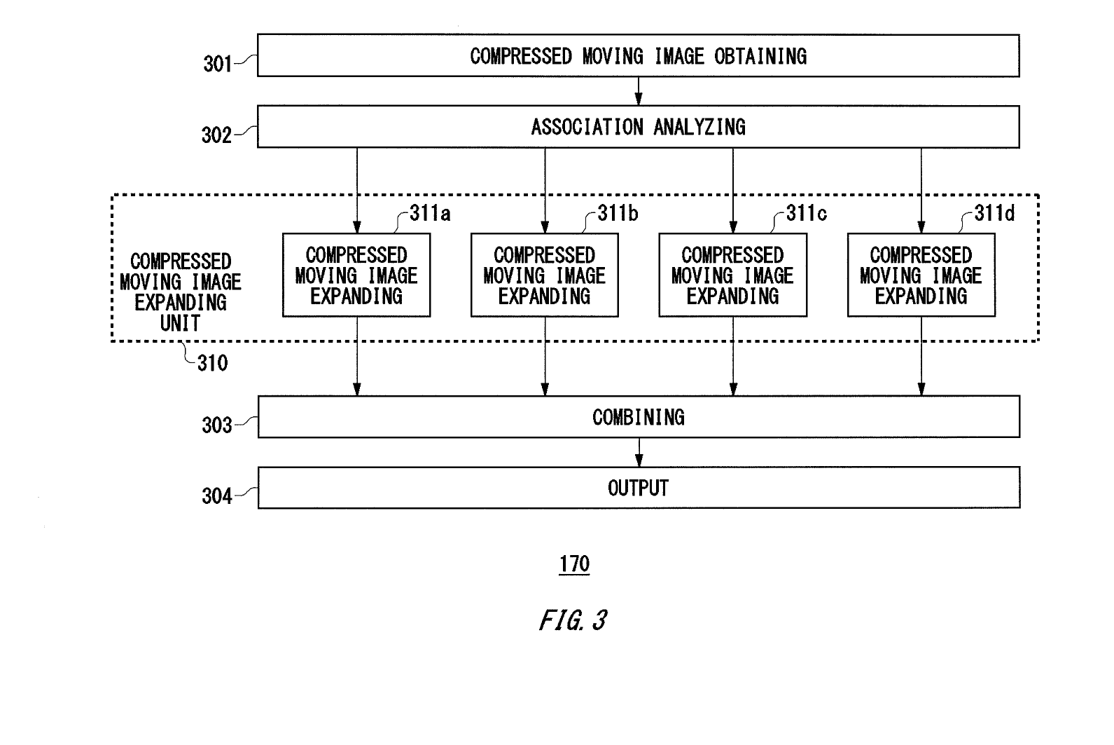

FIG. 3 illustrates an exemplary block configuration of the image processing apparatus 170. The image processing apparatus 170 includes a compressed moving image obtaining section 301, an association analyzing section 302, a compressed moving image expanding unit 310, a combining section 303, and an output section 304. The compressed moving image expanding unit 310 includes a plurality of compressed moving image expanding sections 311a to 311d (hereinafter collectively referred to as the compressed moving image expanding section 311).

The compressed moving image obtaining section 301 obtains the pieces of characteristic region moving image data and the piece of background region moving image data, which are associated with each other, output from the output section 207. The association analyzing section 302, for example, analyzes the added tag information, to retrieve the pieces of characteristic region moving image data and the piece of background region moving image data, which are associated with each other, obtained by the compressed moving image obtaining section 301.

The compressed moving image expanding section 311 decodes the pieces of characteristic region moving image data and the piece of background region moving image data. Specifically speaking, the compressed moving image expanding section 311a decodes the background region moving image data. Each of the compressed moving image expanding sections 311b-311d decodes one of the pieces of characteristic region moving image data. In this way, the compressed moving image expanding sections 311a to 311d obtain a background region moving image and a plurality of characteristic region moving images. Here, the compressed moving image expanding sections 311b to 311d are provided in a one-to-one correspondence with a plurality of characters of different types, and each of the compressed moving image expanding sections 311b to 311d decodes a piece of characteristic region moving image data of one of the types.

The combining section 303 combines together the moving-image-component images obtained by the decoding operation of the compressed moving image expanding section 311. Specifically speaking, the combining section 303 generates moving-image-component images by overlapping the moving-image-component images included in the characteristic region moving images resulting from the decoding operations of the compressed moving image expanding sections 311b to 311d onto the moving-image-component images included in the background region moving image. The output section 304 supplies the moving image including the moving-image-component images generated by the combining section 303, to the display apparatus 180. Here, the output section 304 may record the moving image including the moving-image-component images generated by the combining section 303, onto the image database 175. The image processing apparatus 170 may record the pieces of characteristic region moving image data and the piece of background region moving image data in association with each other which are output from the output section 207, onto the image database 175. In this case, the compressed moving image obtaining section 301 may obtain the pieces of characteristic region moving image data and the piece of background region moving image data in association with each other from the image database 175.

According to the present embodiment, the compressed moving image expanding unit 310 includes a plurality of compressed moving image expanding sections 311 whose number corresponds to the number of the types of characters. In other embodiments, however, the compressed moving image expanding unit 310 may include a single compressed moving image expanding section 311, and the single compressed moving image expanding section 311 may sequentially decode the piece of background region moving image data and the pieces of characteristic region moving image data. When the image processing apparatus 120 provides a single piece of moving image data to the image processing apparatus 170, the single compressed moving image expanding section 311 may decode the provided single piece of moving image data, and the output section 304 may output the moving image obtained by the decoding operation.

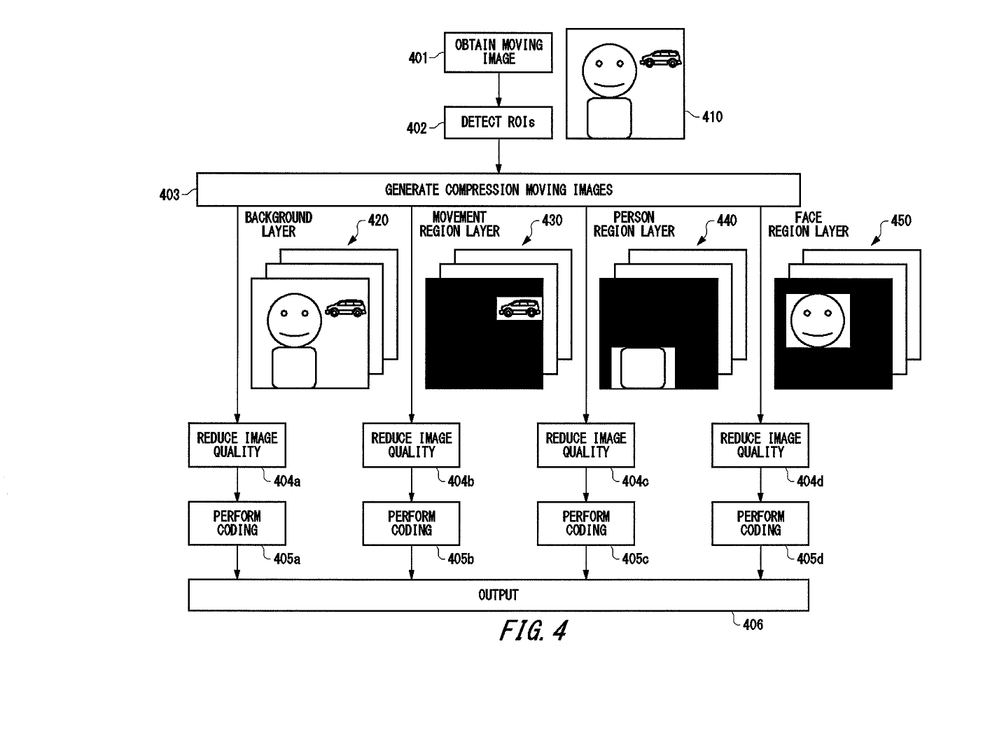

FIG. 4 illustrates an exemplary flow of the operations performed by the image processing apparatus 120. The compressed moving image obtaining section 201 obtains the captured moving image data in the step 401. The compressed moving image expanding section 202 generates a plurality of frame images 410 by decoding the captured moving image data. The characteristic region detecting section 203 detects regions of interest (ROIs), which are shown as an example of the characteristic regions, based on what is shown by each frame image 410 or the frame images 410 in the step 402.

The characteristic region detecting section 203 detects regions containing a person's face, a person's body, and a moving article, as ROIs of different types. For example, the characteristic region detecting section 203 detects a region containing an object that matches a predetermined pattern of a person's face at a degree higher than a predetermined degree of match by way of the pattern matching technique or the like, and designates the detected face region as a ROI. Furthermore, the characteristic region detecting section 203 detects a body region containing an object that matches a pattern of a person's body is higher than a predetermined degree of match by way of the pattern matching technique or the like, and designates the detected region as a ROI. Here, the characteristic region detecting section 203 may detect the body region in the vicinity of the face region.

The characteristic region detecting section 203 identifies a movement region containing a moving article based on what is shown by the plurality of frame images. For example, the characteristic region detecting section 203 identifies, as the movement region, a region in which the pixel values change between frame images more than a predetermined value. Furthermore, the characteristic region detecting section 203 extracts objects from the frame images by using the edge extraction technique or the like. The characteristic region detecting section 203 may subsequently identify objects that match each other at a higher degree than a predetermined degree of match and are positioned differently in different frame images and identify a region containing the identified objects as a movement region.

As stated above, the characteristic region detecting section 203 detects a region satisfying a predetermined condition relating to image contents, as a ROI. Specifically speaking, the characteristic region detecting section 203 detects a region containing an object satisfying a predetermined condition, as a ROI. For example, the characteristic region detecting section 203 detects, as a ROI, a region containing an object which matches a predetermined shape at a higher degree than a predetermined degree of match. Furthermore, the characteristic region detecting section 203 detects, as a ROI, a region in which the image changes more significantly than a predetermined change. For example, the characteristic region detecting section 203 detects, as a ROI, a region in which the pixel values change between frame images more than a predetermined change.

The characteristic region detecting section 203 can detect, as a ROI, a region that shows a portion of a person's head, a portion of a person's body such as a hand, or at least a portion of a living object other than a person, in addition to the person's face and the person's body listed above. Note that the living object includes particular tissues within the living object, for example, a tumor tissue or blood vessel. In addition, the characteristic region detecting section 203 may detect, as a ROI, a region that shows money, a card such as a cash card, a vehicle, or a license plate of a vehicle, apart from the living object.

Other than the pattern matching technique including the template matching, the characteristic region detecting section 203 may use the result of machine learning (for example, adaboost) disclosed in, for example, Japanese Patent Application Publication No. 2007-188419 in order to detect a ROI. For example, the characteristic region detecting section 203 learns the distinctiveness of the image characteristic amount extracted from the image of a predetermined subject, based on the image characteristic amount extracted from the image of the predetermined subject and the image characteristic amount extracted from the image of an subject different from the predetermined subject. The characteristic region detecting section 203 may detect, as a ROI, a region from which the image characteristic amount that has the distinctiveness matching the learned distinctiveness is extracted. In this manner, the characteristic region detecting section 203 can detect, as a ROI, a region showing the predetermined subject. The characteristic region detecting section 203 may detect a ROI which has any shape, for example, a rectangular shape.

Based on the ROIs detected in the above-described manners, the image processing apparatus 120 generates compression moving images in the step 403. Specifically speaking, the image dividing section 204 divides each frame image into the ROIs and the remaining region. Subsequently, the image generating section 205 generates a characteristic region moving image 430, a characteristic region moving image 440, a characteristic region moving image 450 and a background region moving image 420, by duplicating the frame images 410. Specifically speaking, the image generating section 205 generates the characteristic region moving image 450 for the face region, the characteristic region moving image 440 for the person region, the characteristic region moving image 430 for the movement region and the background region moving image 420 for the background region, by duplicating the frame images 410.

The image processing apparatus 120 then uses the value fixing section 211 and the image quality reducing section 221, in order to reduce the image qualities of the characteristic region moving images 430, 440 and 450 and the background region moving image 420 in the steps 404a, 404b, 404c and 404d. Specifically speaking, in the frame image included in each of the characteristic region moving images 430, 440 and 450, the value fixing section 211 maintains the pixel values in the corresponding one of the ROIs defined by the image dividing section 204 and sets the pixel values in the region other than the corresponding ROI at a predetermined value (for example, set the luminance values at zero). Here, the value fixing section 211 may set the pixel values in the non-ROI region at an average pixel value of the region neighboring the ROI.

In the above-described manner, the image generating section 205 and the value fixing section 211 generate the characteristic region moving images 430, 440 and 450 and the background region moving image 420 each of which includes a plurality of frame images having the same view angle. As described in detail later, the image processing apparatus 170 generates a moving image by overlapping, onto the background region moving image 420, moving images in which the values in the non-ROI regions are set at a fixed value, for example, the characteristic region moving images 430, 440 and 450. Hence, the background region moving image 420 and the characteristic region moving images 430, 440 and 450 can be respectively treated as a background layer, a movement region layer, a person region layer, and a face region layer.

In the frame image included in each of the characteristic region moving images 430, 440 and 450, the image quality reducing section 221 reduces the image quality of the image in the ROI according to the type of the character. Specifically speaking, the image qualities of the face, person and movement regions are defined in advance by at least one of the parameters including the resolution, the number of gray levels, and the number of colors. For example, it is designated in advance that the face, person and movement regions are arranged in the descending order of resolution.

The image quality reducing section 221 changes the image of the ROI in the frame image included in each of the characteristic region moving images 430, 440 and 450, into an image having predetermined resolution, number of gray levels and number of colors, in accordance with the type of the character. The image quality reducing section 221 also sets the image quality of the frame image included in the background region moving image so as to be lower than the image qualities of the images in the ROIs. For example, the image quality reducing section 221 sets the resolution of the frame image included in the background region moving image so as to be lower than the resolutions of the images in the ROIs.

The image quality reducing section 221 reduces the frame rates of the background region moving image 420 and the characteristic region moving images 430, 440 and 450. For example, each type of character, that is to say, each of the face, person and movement regions is associated with a predetermined frame rate. The image quality reducing section 221 reduces the frame rate of each of the characteristic region moving images 430, 440 and 450 by discarding, at predetermined intervals, some of the frame images included in each of the characteristic region moving images 430, 440 and 450 in accordance with the predetermined frame rate associated with the type of character. The image quality reducing section 221 also reduces the frame rate of the background region moving image 420 by discarding some of the frame images included in the background region moving image 420 in accordance with the predetermined frame rate.

Here, the image quality reducing section 221a reduces the image quality of the background region moving image 420. The image quality reducing sections 221b, 221c and 221d respectively reduce the image qualities of the characteristic region moving images 430, 440 and 450.

Subsequently, the background region moving image coding section 231a and the characteristic region moving image coding sections 231b to 231d respectively code the corresponding moving images whose image qualities have been reduced by the image quality reducing section 221, in the steps 405a, 405b, 405c and 405d. For example, the background region moving image coding section 231a and the characteristic region moving image coding sections 231b to 231d MPEG-code the corresponding moving images whose image qualities have been reduced by the image quality reducing section 221.

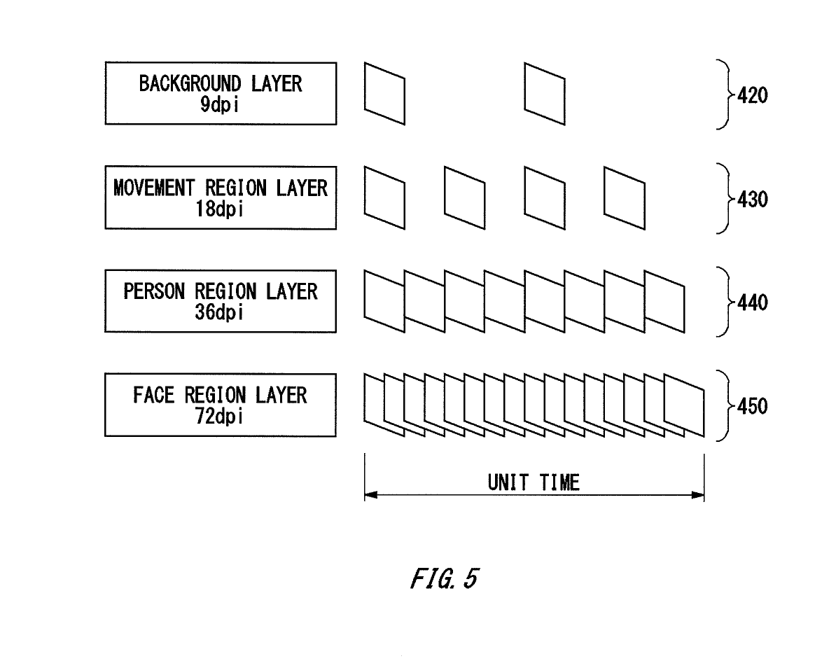

For example, the background region moving image coding section 231a MPEG-codes the background region moving image in accordance with the coding setting for the background region moving image. The characteristic region moving image coding sections 231b, 231c and 231d respectively MPEG-code the corresponding characteristic region moving images in accordance with the coding settings respectively for the movement, person and face region moving images. Here, the coding setting includes setting a quantization table for MPEG coding, for example. The coding setting is described with reference to FIG. 5.

In the step 406, the associating section 206 associates, to each other, a piece of background region moving image data and a plurality of pieces of characteristic region moving image data which are obtained by the coding operations of the background region moving image coding section 231a and the characteristic region moving image coding sections 231b to 231d, by adding tag information, and the output section 207 outputs the piece of background region moving image data and the pieces of characteristic region moving image data to the image processing apparatus 170. Here, the associating section 206 may add timing information to the tag information, where the timing information is, for example, time stamps and includes information indicating the display timings of the frame images included in the background region moving image and the characteristic region moving images. The associating section 206 may add, to the tag information, characteristic region information indicating the range of each characteristic region, identification information identifying the image capturing apparatus 100 which has generated the captured moving image data from which the background region moving image and the characteristic region moving images are generated, and other information.

As described above, the characteristic region detecting section 203 detects a plurality of characteristic regions showing different types of subjects, from a plurality of moving-image-component images included in a moving image. The compressing section 240 compresses a plurality of characteristic region moving images respectively at strengths determined in accordance with the types of the subjects. In the present embodiment, the different types of subjects include, for example, a person's face and a person's body. In other embodiments, however, the different types of subjects may include the license plate of an automobile and a different part of an automobile than the license plate.

The different types of subjects may include front and side views of a person's face. The different types of subjects may include stationary and moving subjects. The characteristic region detecting section 203 may detect, as a plurality of characteristic regions with different types of characters, a plurality of regions containing a plurality of subjects which are positioned away from the image capturing apparatus 100 by different distances.

The compression strengths at which the compressing section 240 compresses the characteristic region moving images may descend in the order of a movement region, a person's body, the side view of a person's face, and the front view of a person's face, which are exemplary characters of different types. Since the image processing system 10 is used as a monitoring system in the present embodiment, the image processing system 10 is configured to detect a region containing a person's face as a ROI and set the image quality of the detected ROI higher than the image quality of the non-ROI region. The image processing system 10, however, can be used for capturing images of a street, for example. When used for such a purpose, the image processing system 10 may detect a region containing a person's face as a ROI and set the image quality of the detected ROI lower than the image quality of the non-ROI region in order to protect personal information. For example, the compression strengths at which the compressing section 240 compresses the characteristic region moving images and the background region moving image may descend in the order of the front view of a person's face, the side view of a person's face, a person's body, a movement region and a background region.

The characteristic region detecting section 203 may detect a plurality of characteristic regions containing subjects that move at different speeds, from a plurality of frame images. In this case, as the speeds of the subjects increase, the frame rates of the moving images obtained by the image quality reducing section 221 by converting the characteristic region moving images increase. Which is to say, the compressing section 240 may compress the characteristic region moving images respectively at strengths determined in accordance with the speeds of their subjects.

As described above, the image processing apparatus 120 sets, at fixed values, the values in the non-ROI regions in the frame images respectively included in the characteristic region moving images, and generates a plurality of characteristic region moving images and a background region moving image which all have the same view angle. Therefore, the image processing apparatus 120 may be able to use a general-purpose coder for compressing the characteristic region moving images at high compression rates without using a specially designed coder. For example, when the characteristic region moving images are coded by way of motion vectors as in the MPEG coding technique, the pixel values may often have a differential value of 0 in the macroblocks within the non-ROI region whose values are set at a fixed value. As a result, the above-mentioned value fixing operation may be able to lower the manufacturing cost of the image processing apparatus 120 with it being possible to maintain high compression rates.

In the above description, the compressing section 240 compresses the characteristic region moving images including the frame images in which the values in the non-ROI regions are set at fixed values. The compressing section 240 may clip the images within the ROIs from the frame images included in the characteristic region moving images, compress the clipped images, and output the compressed images as the characteristic region moving images.

When the characteristic region detecting section 203 detects no ROIs, the output section 207 outputs the background region moving image data output from the compressing section 240a, to the image processing apparatus 170. In this case, the image generating section 205 may not need to generate the characteristic region moving images 430, 440 and 450. Under the condition that the characteristic region detecting section 203 detects ROIs, the image generating section 205 generates the characteristic region moving images 430, 440 and 450, and the output section 207 outputs a plurality of pieces of characteristic region moving image data and a piece of background region moving image data, which are obtained in the above-described manner, to the image processing apparatus 170. During this period, the compressing section 240a may continue compressing the background region moving image 420 at a predetermined background region compression rate.

While the characteristic region detecting section 203 detects no ROIs, the compressing section 240 may compress the background region moving image at a predetermined no-ROI compression rate which is lower than the above background region compression rate and higher than the compression rates for the characteristic region moving images. Under the condition that the characteristic region detecting section 203 detects ROIs, the compressing section 240 may compress the background region moving image at the above background region compression rate. Here, the compressing section 240 may compress the characteristic region moving images at compression rates lower than the no-ROI compression rate.

The compressing section 240 may compress the background region moving image at the no-ROI compression rate until a predetermined time period elapses after the characteristic region detecting section 203 detects ROIs, and compress the background region moving image at the background region compression rate after the predetermined time period has elapsed. With such a configuration, even when the characteristic region detecting section 203 does not detect, as a ROI, a region which is originally expected to be detected as a ROI, the image processing apparatus 120 may be able to provide a background region moving image with a reasonably high image quality. The compressing section 240 may compress the respective regions at different compression rates in the following manner. The characteristic region detecting section 203 detects ROIs in the frame images, and the positions of the detected ROIs are used to estimate a ROI in a different frame image. In the different frame image, the region containing the ROI has a higher image quality than the non-ROI region.

FIG. 5 shows, as an example, the image qualities of the characteristic region moving images and the image quality of the background region moving image. To simplify the explanation, it is assumed that the captured moving image data obtained by the compressed moving image obtaining section 201 has a frame rate of 16 fps and that the frame images included in the captured moving image data have a resolution of 72 dpi.

The resolution ratio of the resolution of the frame image included in the background region moving image 420 after the image-quality reduction to the resolution of the frame image 410 included in the captured moving image is set at 1/8 in advance. The image quality reducing section 221 generates 9-dpi frame images by discarding some of the pixels of the frame images included in the background region moving image 420 before the image-quality reduction, where the resolution of 9 dpi is one-eighth of the resolution of the frame images included in the background region moving image 420 before the image-quality reduction which is generated by the image generating section 205 by duplicating the captured moving image. Furthermore, the frame rate ratio of the frame rate of the background region moving image 420 after the image-quality reduction to the frame rate of the captured moving image is set at 1/8 in advance. The image quality reducing section 221 generates a 2-fps background region moving image 420 by discarding some of the frame images included in the background region moving image 420 before the image-quality reduction, where the frame rate of 2 fps is one-eighth of the frame rate of the background region moving image 420 before the image-quality reduction.

Similarly, the resolution ratios and the frame rate ratios are designated in advance in association with the respective characteristic region moving images. For example, the resolution ratio and the frame rate ratio are set at 1/4 for the characteristic region moving image 430, the resolution ratio and the frame rate ratio are set at 1/2 for the characteristic region moving image 440, and the resolution ratio and the frame rate ratio are set at 1/1 for the characteristic region moving image 450. In this case, the image quality reducing section 221b generates the characteristic region moving image 430 with the frame rate of 4 fps and the frame image resolution of 18 dpi. The image quality reducing section 221c generates the characteristic region moving image 440 with the frame rate of 8 fps and the frame image resolution of 36 dpi. The image quality reducing section 221d generates the characteristic region moving image 450 with the frame rate of 16 fps and the frame image resolution of 72 dpi.

In the above-described exemplary case, the image quality reducing section 221 reduces the image qualities of the frame images by discarding some of the pixels of the frame images included in the characteristic region moving images and the background region moving image. Alternatively, the image quality reducing section 221 may reduce the image qualities of the frame images by using filters each of which passes a predetermined frequency band, for example, low pass filters. If such is the case, the filter associated with each type of character may have predetermined properties, where the different types of characters include the background region, the movement region, the person region, and the face region and the filter properties include the frequency band passing through each filter and the degree of the passage.

In addition to or in place of the image-quality reduction performed by the image quality reducing section 221, the coding section 231 may reduce the image qualities of the frame images. For example, the coding section 231 can reduce the image qualities by increasing the values of the quantization tables used for the MPEG coding. The values of each quantization table may be set in advance in accordance with a corresponding one of the different types of characters. For example, the background region moving image coding section 231a and the characteristic region moving image coding sections 231b to 231d may code the corresponding moving images by using the quantization tables with predetermined values. Referring to the quantization tables, the values are associated with frequency components. Such values may be set in advance differently in accordance with the different types of characters.

The image quality reducing section 221 may also average a plurality of frame images included in the background region moving image. In this way, when an object representing a moving article is included in the frame images, the image quality reducing section 221 can obtain a frame image in which the object representing the moving article is averaged. When such averaged frame images are successively displayed, a viewer may enjoy watching smooth movement of the moving article.

According to the above-described embodiment, the image generating section 205 duplicates the captured moving image to generate the characteristic region moving images and the background region moving image, and the compressing section 240 compresses the generated characteristic region moving images and background region moving image by discarding some of the frame images and pixels. Alternatively, the image generating section 205 may generate the characteristic region moving images and the background region moving image with lowered frame rates by discarding some of the frame images included in the captured moving image in accordance with the frame rate ratios. After this, the value fixing section 211 performs the value fixing operation, and the image quality reducing section 221 reduces the resolutions to reduce the image qualities of the characteristic region moving images and the background region moving image.

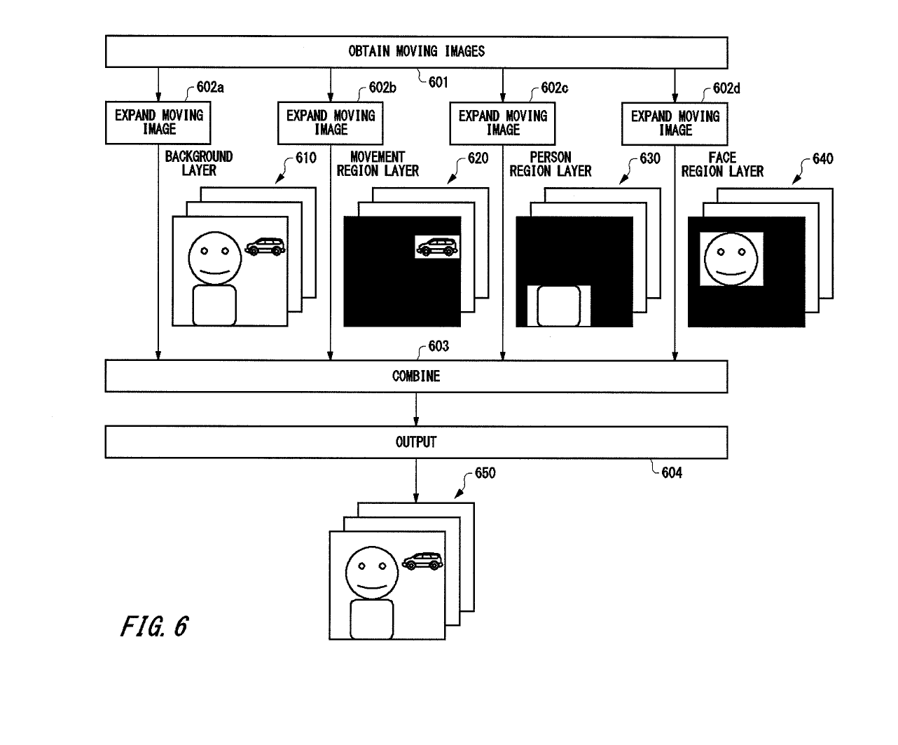

FIG. 6 illustrates an exemplary flow of the operations performed by the image processing apparatus 170. The compressed moving image obtaining section 301 obtains a plurality of pieces of characteristic region moving image data and a piece of background region moving image data which are associated with each other, from the image processing apparatus 120, and obtains timing information, identification information identifying the image capturing apparatus 100 and other information with reference to the added tag information, in the step 601. The compressed moving image expanding section 311 decodes the pieces of characteristic region moving image data and the piece of background region moving image data, to generate a background region moving image 610 representing a background layer in the step 602a. At the same time, the compressed moving image expanding section 311 generates a characteristic region moving image 620 representing a movement region layer, a characteristic region moving image 630 representing a person region layer, and a characteristic region moving image 640 representing a face region layer in the steps 602b, 602c and 602d .

The combining section 303 combines together the frame images included in the background region moving image 610 and the characteristic region moving images 620, 630 and 640 in the step 603. Here, the combining section 303 enlarges the frame images included in the background region moving image 610 and the characteristic region moving images 620, 630 and 640 in accordance with their respective resolutions in such a manner that the identical subjects in the respective frame images overlap each other, and layers the enlarged frame images to generate a combined frame image.

The combining section 303 clips the images of the characteristic regions from the frame images included in the characteristic region moving images 620, 630, and 640, and overlays the clipped images onto the frame image included in the background region moving image 610. In this manner, the combining section 303 generates the combined frame image. When the background region moving image 610 and the characteristic region moving images 620, 630 and 640 have different frame rates, the combining section 303 combines together the most recent frame images of the background region moving image 610 and the characteristic region moving images 620, 630 and 640.

In the above-described manner, the combining section 303 generates a combined frame image. The combining section 303 further generates a combined moving image 650 including a plurality of combined frame images. The output section 304 selects the display apparatus 180 which is to display the combined moving image with reference to the tag information obtained by the compressed moving image obtaining section 301, and supplies the combined moving image to the selected display apparatus 180 in the step 604.

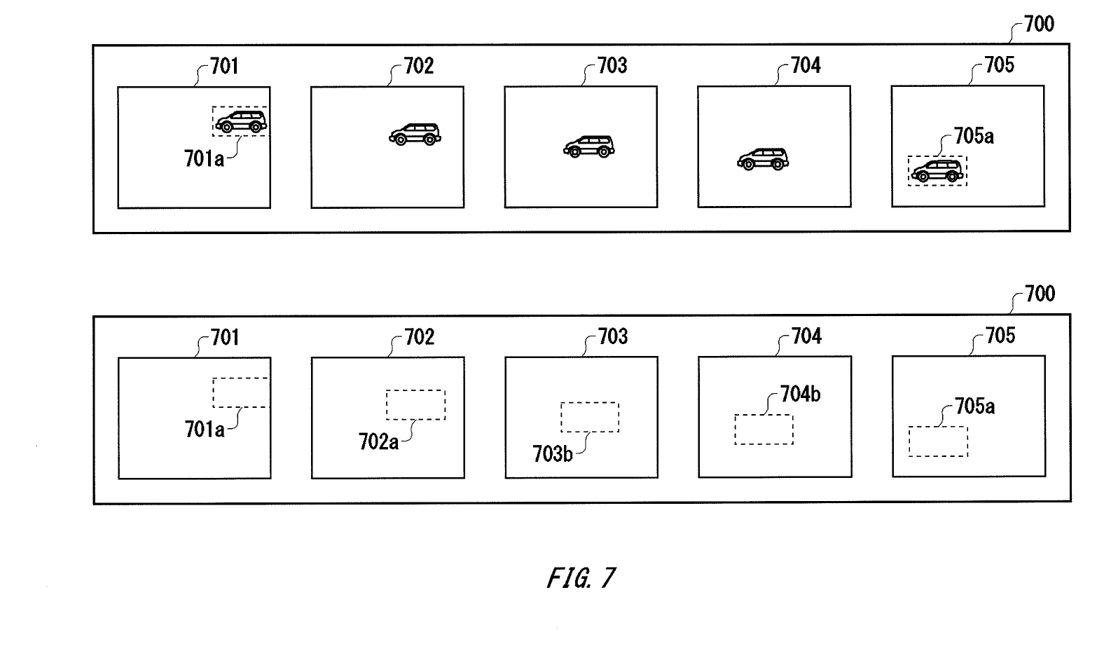

FIG. 7 illustrates an exemplary method for identifying a characteristic region in a plurality of moving-image-component images. In a moving image 700 of FIG. 7, the characteristic region detecting section 203 detects a characteristic region in selected images as shown on the upper side. Also in the moving image 700 of FIG. 7, the characteristic region identifying section 252 identifies a characteristic region in non-selected images as shown on the lower side. The moving image 700 includes successive moving-image-component images 701 to 705.

The moving-image-component images 701 and 705 are selected images which are selected from the moving-image-component images included in the moving image 700. For example, the moving-image-component images 701 and 705 are I frames defined in relation to the MPEG coding technique. The moving-image-component images 702, 703 and 704 are non-selected images which are not selected from the moving-image-component images included in the moving image 700. For example, the moving-image-component images 702, 703 and 704 are B or P frames defined in relation to the MPEG coding technique.

Since the moving-image-component images 701 and 705 are selected images, the characteristic region detecting section 203 detects a characteristic region 701a in the moving-image-component image 701 and detects a characteristic region 705a in the moving-image-component image 705 as shown in the upper side of FIG. 7. Since the moving-image-component images 702, 703 and 704 are non-selected images, the characteristic region detecting section 203 detects no characteristic regions in the moving-image-component images 702, 703 and 704 as shown in the lower side of FIG. 7.

The characteristic region identifying section 252 refers to the positions of the characteristic regions 701a and 705a in order to identify a characteristic region 702a in the moving-image-component image 702, a characteristic region 703b in the moving-image-component image 703, and a characteristic region 704b in the moving-image-component image 704. As a result, the characteristic regions are respectively identified in the moving-image-component images 701 to 705 as shown in the lower side of FIG. 7.

The characteristic region identifying section 252 identifies the characteristic regions 702a, 703b and 704b, based on the positions of the characteristic regions 701a and 705a and the motion vector of the moving image 700. Here, the characteristic region identifying section 252 may identify the characteristic regions 702a, 703b and 704b based on the positions of the characteristic regions 701a and 705a by way of the linear interpolation technique.

According to the image processing apparatus 120 relating to the present embodiment, it is the characteristic region detecting section 203 which detects characteristic regions in selected images as described above. On the other hand, it is the characteristic region identifying section 252 which identifies characteristic regions in non-selected images based on the characteristic regions detected in the selected images. By putting the image processing apparatus 120 relating to the present embodiment with such a configuration into a practical use as a monitoring system, it may be possible to lower the number of characteristic region detecting operations by the characteristic region detecting section 203. As a consequence, the image processing apparatus 120 relating to the present embodiment may be able to shorten the processing time required to identify characteristic regions in moving-image-component images included in a moving image.

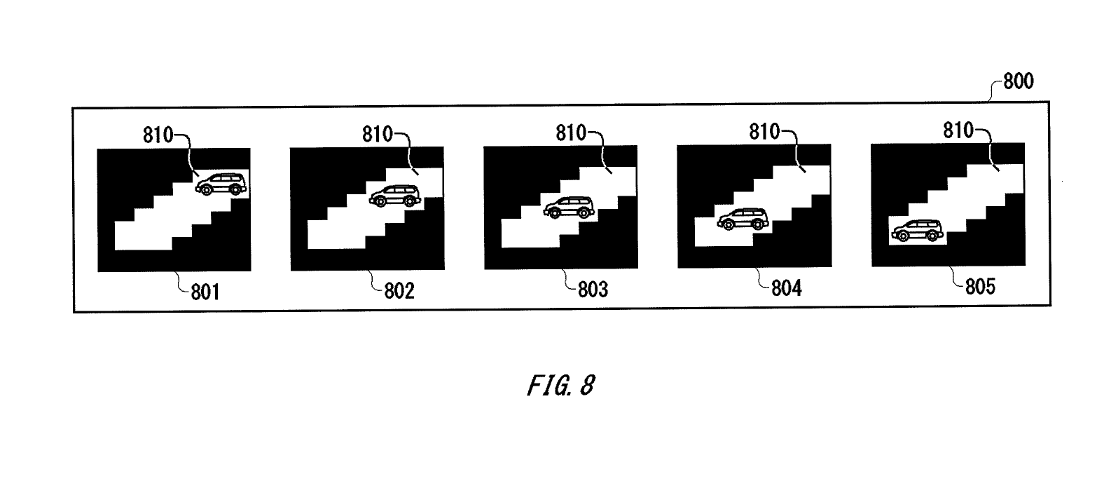

FIG. 8 illustrates an exemplary method to set, at a fixed value, the values of a region other than an inclusion region. In a moving image 800 shown in FIG. 8, the inclusion region identifying section 261 identifies an inclusion region and the value fixing section 211 sets, at a fixed value, the values of the region other than the inclusion region. The moving image 800 includes successive moving-image-component images 801 to 805.

The characteristic regions in the moving-image-component images 801 and 805 are detected by the characteristic region detecting section 203. On the other hand, the characteristic regions in the moving-image-component images 802, 803 and 804 are identified by the characteristic region identifying section 252. Here, the inclusion region identifying section 261 identifies an inclusion region 810 in each of the moving-image-component images 801 to 805. The inclusion region 810 extends so as to include the characteristic regions of the moving-image-component images 801 to 805. In each of the moving-image-component images 801 to 805, the value fixing section 211 sets the pixel values of the region other than the inclusion region 810 at a value “0”.

As described above, the image processing apparatus 120 relating to the present embodiment identifies an inclusion region including characteristic regions of a plurality of moving-image-component images, and then sets the values of the region other than the identified inclusion region at a fixed value. By putting the image processing apparatus 120 relating to the present embodiment with such a configuration into a practical use as a monitoring system, the image processing apparatus 120 relating to the present embodiment can reduce the difference between the moving-image-component images in the pixel values of the region other than the inclusion region. As a result, the image processing apparatus 120 relating to the present embodiment can achieve a high compression rate for the differential data between the moving-image-component images.

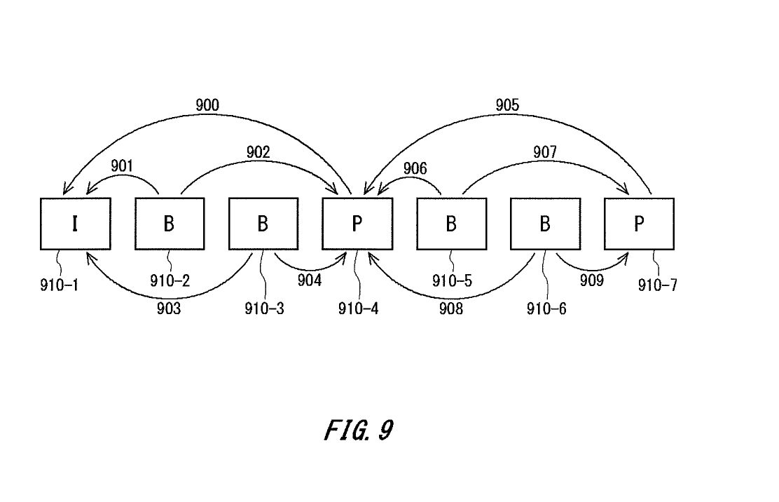

FIG. 9 illustrates an exemplary correlation between moving-image-component images. As described above, the captured moving image data supplied from the image capturing apparatus 100 is compressed by using a compression format based on inter-frame compression. In this case, the captured moving image data includes differential data representing the difference between an image of a partial region (for example, a macroblock or slice) in a given moving-image-component image and an image of an image region having a corresponding size in a different moving-image-component image. The captured moving image data also includes motion vector information indicating the difference between the position of the partial region in the given moving-image-component image and the position of the image region which is a difference target region compared with the partial region.

Here, these regions are related to each other by the motion vector. In the present embodiment, the difference target region compared with the partial region is referred to as a region correlated to the partial region. Also in the present embodiment, when a partial region in a given moving-image-component image is related to a partial region in a different moving-image-component image by a motion vector, these partial regions are directly correlated with each other. Furthermore, the regions respectively including these partial regions with a direct correlation are directly correlated with each other. Moreover, the moving-image-component images respectively including these partial regions with a direct correlation are directly correlated with each other.

Each moving-image-component image is related to a different moving-image-component image by a motion vector. When a partial region in a given moving-image-component image is directly correlated with a partial region in a different moving-image-component image, the partial region in the different moving-image-component image may also be directly correlated with a partial region in a further different moving-image-component image. In this case, the partial region in the further different moving-image-component image is indirectly correlated with the partial region in the given moving-image-component image. The regions respectively including these partial regions with an indirect correlation are indirectly correlated with each other. Also, the moving-image-component images respectively including these partial regions with an indirect correlation are indirectly correlated with each other. Which is to say, when a partial region in a given moving-image-component image is related to a partial region in a different moving-image-component image through a plurality of direct correlations, these partial regions are indirectly correlated with each other.

From among moving-image-component images 910-1 to 910-7 (hereinafter may be collectively referred to as the moving-image-component images 910) included in the captured moving image shown in FIG. 9, the moving-image-component image 910-1 is an I frame, the moving-image-component images 910-4 and 910-7 are P frames, and the remaining moving-images 910 are B frames. In this case, the moving-image-component images 910-2 to 910-4 may be directly correlated with the moving-image-component image 910-1, for example. In FIG. 9, the moving-image-component images that can have a direct correlation are related to each other by using arrows 901 to 909 representing the direction of inter-frame prediction.

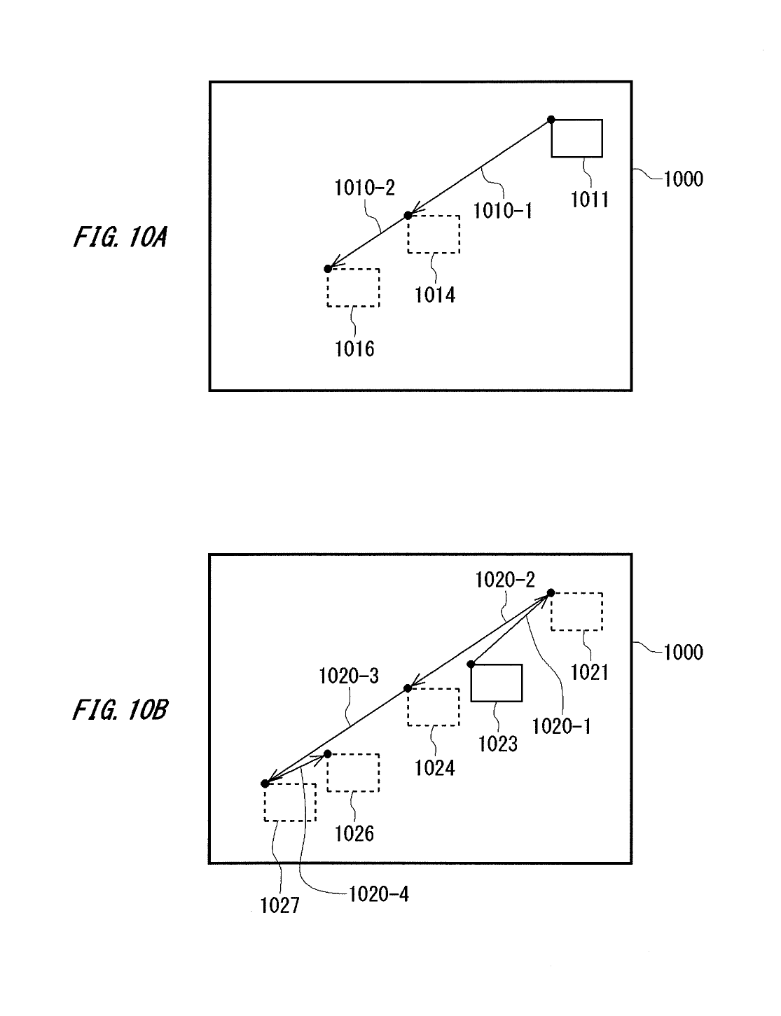

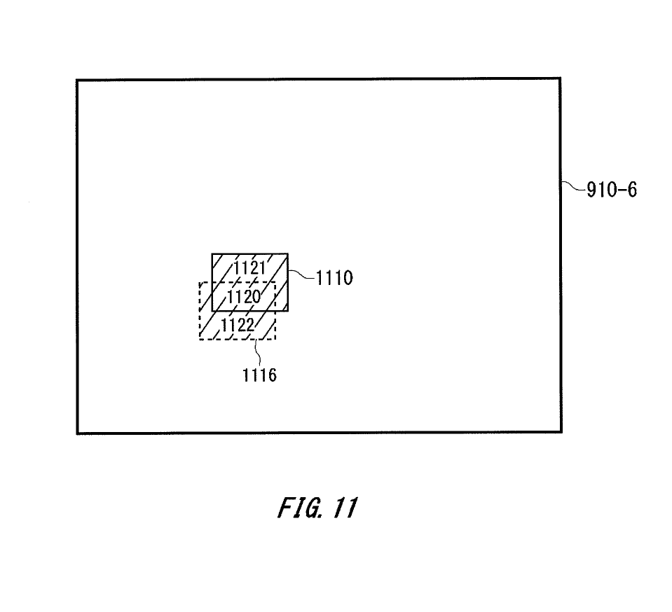

FIGS. 10A and 10B illustrate, as an example, characteristic regions which are correlated with each other. In the following description, the respective image regions of the moving-image-component images 910 are represented by a single image region 1000. Referring to FIG. 10A, a characteristic region 1011 is detected by the characteristic region detecting section 203 in the moving-image-component image 910-1. For example, the characteristic region detecting section 203 detects the characteristic region 1011 by using image recognition processing such as template matching.

Starting from the macroblock included in the characteristic region 1011, the characteristic region identifying section 252 traces the motion vector associated with the macroblock across a plurality of moving-image-component images. Here, the motion vector associated with the macroblock may be information indicating the difference between the position of the macro block and the position of the image region which is the difference target to be compared with the macroblock. When at least a partial image region of the macroblock is a difference target to be compared with a different macroblock, the motion vector associated with the macroblock may be information indicating the difference between the position of the partial image region of the macroblock and the position of the different macroblock.

In the above manner, the characteristic region identifying section 252 identifies a region in a different moving-image-component image which is directly or indirectly correlated with the macroblock included in the characteristic region 1011. The characteristic region identifying section 252 identifies, as a characteristic region in the different moving-image-component image, a region including the directly or indirectly correlated region. For example, the characteristic region identifying section 252 may identify, as the characteristic region in the different moving-image-component image, a region that includes the directly or indirectly correlated region and has the same size as the characteristic region 1011.

For example, the characteristic region identifying section 252 can identify a characteristic region 1014 in the moving-image-component image 910-4 which is directly correlated with the moving-image-component image 910-1, based on the position of the characteristic region 1011, the correlation 900 and the motion vector associated with the moving-image-component image 910-4. Also, the characteristic region identifying section 252 can identify a characteristic region 1016 in the moving-image-component image 910-6 which is indirectly correlated with the moving-image-component image 910-1, based on the correlation 908 and the motion vector associated with the moving-image-component image 910-6. In this way, the characteristic region identifying section 252 can calculate a characteristic region vector 1010-1 indicating the difference in position between the characteristic regions 1011 and 1014, and a characteristic region vector 1010-2 indicating the difference in position between the characteristic regions 1014 and 1016.

Referring to FIG. 10B, the characteristic region detecting section 203 detects a characteristic region 1023 in the moving-image-component image 910-3. For example, the characteristic region detecting section 203 detects the characteristic region 1023 by using image recognition processing such as template matching.

The characteristic region identifying section 252 can identify a characteristic region 1021 in the moving-image-component image 910-1 which is directly correlated with the moving-image-component image 910-3, based on the position of the characteristic region 1023, the correlation 903 and the motion vector associated with the moving-image-component image 910-3. Also, the characteristic region identifying section 252 can identify a characteristic region 1024 in the moving-image-component image 910-4 which is indirectly correlated with the moving-image-component image 910-3, based on the correlation 900 and the motion vector associated with the moving-image-component image 910-4.

Furthermore, the characteristic region identifying section 252 can identify a characteristic region 1027 in the moving-image-component image 910-7 which is indirectly correlated with the moving-image-component image 910-3, based on the correlation 905 and the motion vector associated with the moving-image-component image 910-7. Also, the characteristic region identifying section 252 can identify a characteristic region 1026 in the moving-image-component image 910-6 which is indirectly correlated with the moving-image-component image 910-3, based on the correlation 909 and the motion vector associated with the moving-image-component image 910-6. In this manner, the characteristic region identifying section 252 can calculate a characteristic region vector 1020-1 indicating the difference in position between the characteristic regions 1023 and 1021, a characteristic region vector 1020-2 indicating the difference in position between the characteristic regions 1021 and 1024, a characteristic region vector 1020-3 indicating the difference in position between the characteristic regions 1024 and 1027, and a characteristic region vector 1020-4 indicating the difference in position between the characteristic regions 1027 and 1026.

As described above, the characteristic region identifying section 252 can identify the position of a characteristic region in a non-selected image based on the position of a characteristic region in a selected image and a motion vector across a plurality of moving-image-component images. Specifically speaking, the characteristic region identifying section 252 identifies the position of a characteristic region in a non-selected image which is indirectly correlated with a characteristic region in a selected image by way of a motion vector, based on the position of the characteristic region in the selected image, the motion vector of the non-selected image and the motion vectors of one or more moving-image-component images which are directly or indirectly correlated with the non-selected image and the characteristic region in the selected image by way of motion vectors. More specifically, the characteristic region identifying section 252 identifies a correlated region which is indirectly correlated with the characteristic region in the selected image by way of the motion vector, and then identifies, as the characteristic region, a region including at least part of the identified correlated region. As a result, the characteristic region identifying section 252 can identify a characteristic region in a non-selected image within a short time period.

FIG. 11 illustrates, as an example, the characteristic region in the moving-image-component image 910-6. A characteristic region 1110 is detected by the characteristic region detecting section 203 by image recognition processing such as template matching. A correlated region 1116 is identified by the characteristic region identifying section 252 based on direct or indirect correlation of a characteristic region in a selected image, as described with reference to FIG. 9, FIG. 10A and FIG. 10B. According to the description made with reference to FIG. 9, FIG. 10A and FIG. 10B, the characteristic region identifying section 252 identifies a correlated region as a characteristic region. According to an exemplary case described with reference to FIG. 11, however, the characteristic region identifying section 252 identifies a characteristic region with reference to a characteristic region detected by the characteristic region detecting section 203 and a correlated region.

Specifically speaking, the characteristic region identifying section 252 may identify, as a characteristic region, a region including the characteristic region 1110 detected by the characteristic region detecting section 203 and the correlated region 1116. More specifically, the characteristic region identifying section 252 may identify, as a characteristic region, a total region of the characteristic region 1110 detected by the characteristic region detecting section 203 and the correlated region 1116. As described, the characteristic region identifying section 252 identifies, as a characteristic region, a region including at least one of a characteristic region detected by the characteristic region detecting section 203 in a non-selected image and a correlated region in the non-selected image. With such a configuration, the image processing apparatus 120 relating to the present embodiment can identify, as a characteristic region, a correlated region estimated based on a motion vector, even when failing to detect a characteristic region by the image recognition processing. As a consequence, the image processing apparatus 120 relating to the present embodiment can detect a characteristic region more robustly.

The characteristic region detecting section 203 may detect a characteristic region in every one of the moving-image-component images. The characteristic region identifying section 252 may identify correlated regions based on every one of the characteristic regions detected from a plurality of moving-image-component images by the characteristic region detecting section 203 in the moving-image-component images. In this manner, the present embodiment can significantly increase the robustness of the characteristic region detecting operation.

Alternatively, the characteristic region identifying section 252 may identify, as a characteristic region, a region 1120 included in both the characteristic region 1110 detected by the characteristic region detecting section 203 and the correlated region 1116. As stated, the characteristic region identifying section 252 may identify, as a characteristic region, a region included in both a characteristic region detected by the characteristic region detecting section 203 in a non-selected image and a correlated region in the non-selected image. With such a configuration, the image processing apparatus 120 relating to the present embodiment can identify, as a characteristic region, a region which is relatively more likely to show a subject that is expected to be detected as a characteristic region. As described above, the characteristic region identifying section 252 identifies a correlated region in a non-selected image which is directly or indirectly correlated with a characteristic region in a selected image, and identifies, as a characteristic region, a region including at least part of the identified correlated region.

The compressing section 240 may compress an image of a region other than the characteristic region identified by the characteristic region identifying section 252 at a higher compression strength than the characteristic region identified by the characteristic region identifying section 252. The compressing section 240 may compress regions 1121 and 1122 each of which is included in one of the characteristic region 1110 and the correlated region 1116 at a higher compression strength than the region 1120. As stated above, the compressing section 240 may compress the image of the region which is included in one of the characteristic region detected by the characteristic region detecting section 203 in a non-selected image and a correlated region in the non-selected image at a higher compression strength than the image of the region included in both the characteristic region detected by the characteristic region detecting section 203 in the non-selected image and the correlated region in the non-selected image. With such a configuration, the image processing apparatus 120 relating to the present embodiment can increase, within a region identified as a characteristic region, the amount of information of the region which is relatively more likely to show a subject that is expected to be detected as a characteristic region.

The above describes the operation of the characteristic region identifying section 252 with the use of the I, P and B frames for each of which a coding method is separately selected. The characteristic region identifying section 252 can also identify a correlated region in the above-described manner even when there is an intra-coded macroblock in the P and B frames. Furthermore, the characteristic region identifying section 252 can also identify a correlated region in the above-described manner in captured moving image data which is coded in such a manner that inter-frame coding and intra-frame coding is selected for each macroblock or slice.

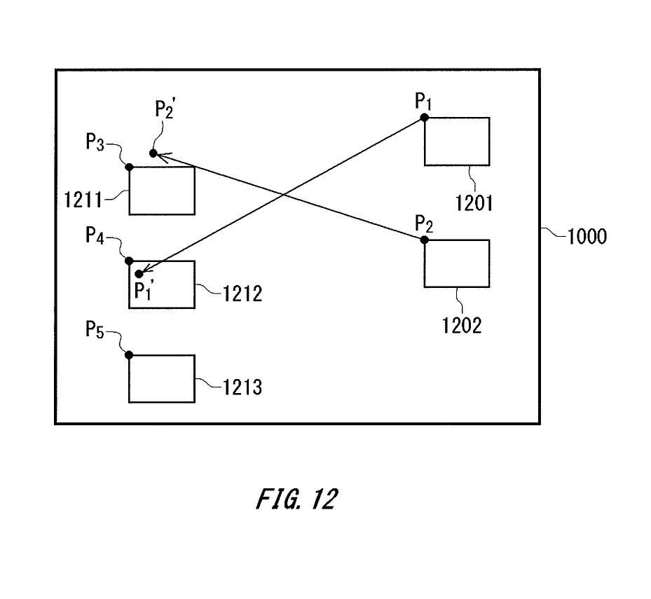

FIG. 12 illustrates characteristic regions distinguished from each other, as an example. In FIG. 12, characteristic regions 1201 and 1202 are both present the moving-image-component image 910-1. The characteristic regions 1201 and 1202 may be detected by the characteristic region detecting section 203 in the moving-image-component image 910-1, or identified by the characteristic region identifying section 252 in the moving-image-component image 910-1. Furthermore, characteristic regions 1211, 1212 and 1213 are detected by the characteristic region detecting section 203 in the moving-image-component image 910-7.

The characteristic region identifying section 252 identifies the position of a correlated region based on the position and correlation of the characteristic region 1201. For example, the characteristic region identifying section 252 identifies a point P1′ corresponding to a point P1 of the characteristic region 1201. The characteristic region identifying section 252 also identifies a point P2′ corresponding to a point P2 of the characteristic region 1202. The characteristic region identifying section 252 then compares the position of a point P3 of the characteristic region 1211 which is expected to correspond to the point P1 or P2, the position of a point P4 of the characteristic region 1212 which is expected to correspond to the point P1 or P2, and the position of a point P5 of the characteristic region 1213 which is expected to correspond to the point P1 or P2, with the positions of the points P1′ and P2′. For example, the characteristic region identifying section 252 calculates the distance between the point P1′ and each of the points P3, P4 and P5 and the distance between the point P2′ and each of the points P3, P4 and P5.

Subsequently, the characteristic region identifying section 252 identifies a pair of points which produce a distance equal to or shorter than a predetermined value. For example, the characteristic region identifying section 252 identifies a pair of the points P4 and P1′ and a pair of the points P3 and P2′, as the pair of points which produce the distance equal to or shorter than the predetermined value. The characteristic region identifying section 252 then judges that the characteristic region 1212 including the point P4 shows the same subject as the characteristic region 1201. Also, the characteristic region identifying section 252 judges that the characteristic region 1211 including the point P3 shows the same subject as the characteristic region 1202. Furthermore, the characteristic region identifying section 252 judges that the characteristic region 1213 shows a different subject from the characteristic regions 1201 and 1202. In this manner, the characteristic region identifying section 252 can estimate whether an object in a given moving-image-component image is the same as an object in a different moving-image-component image.

As explained above, when the distance between the position of a characteristic region detected by the characteristic region detecting section 203 in a non-selected image and the position of a correlated region in the non-selected image is larger than a predetermined value, the characteristic region identifying section 252 identifies the correlated region in the non-selected image as a characteristic region showing an object different from the object included in the characteristic region detected by the characteristic region detecting section 203 in the non-selected image. Also, when the distance between the position of the characteristic region detected by the characteristic region detecting section 203 in the non-selected image and the position of the correlated region in the non-selected image is shorter than or equal to the predetermined value, the characteristic region identifying section 252 may identify at least part of the correlated region in the non-selected image as a characteristic region showing an object same as the object included in the characteristic region detected by the characteristic region detecting section 203 in the non-selected image.

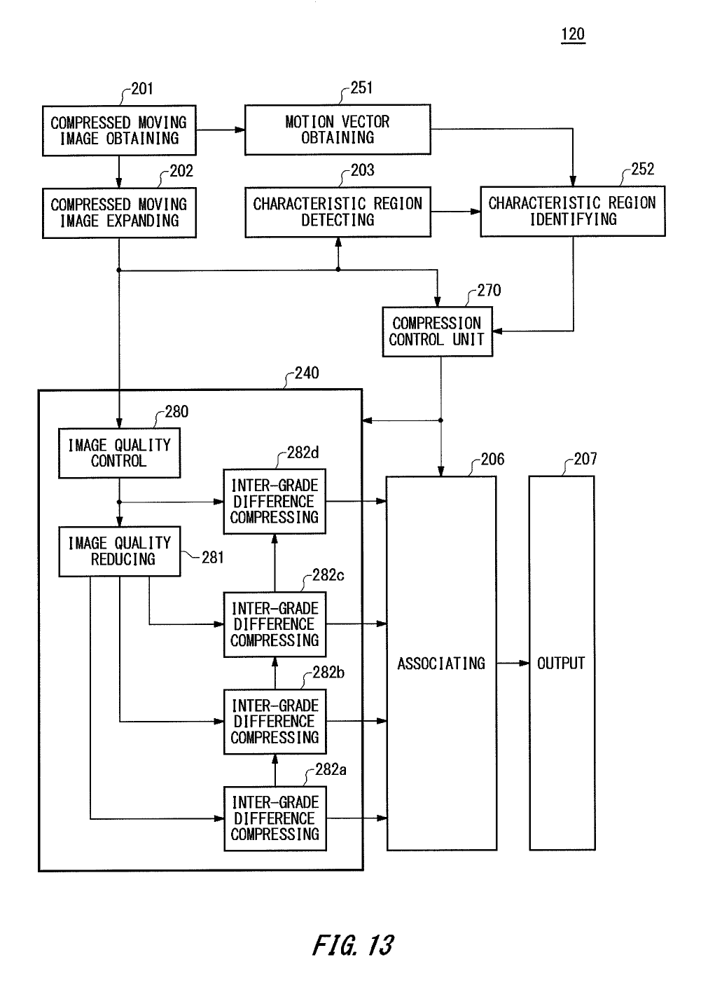

FIG. 13 illustrates another exemplary block configuration of the image processing apparatus 120. The image processing apparatus 120 includes the compressed moving image obtaining section 201, the compressed moving image expanding section 202, the characteristic region detecting section 203, the compressing section 240, the motion vector obtaining section 251, the characteristic region identifying section 252, the compression control unit 270, the associating section 206, and the output section 207. The compressing section 240 includes an image quality control section 280, an image quality reducing section 281, a plurality of inter-grade difference compressing sections 282a to 282d (hereinafter collectively referred to as the inter-grade difference compressing sections 282).

The compressed moving image obtaining section 201, the compressed moving image expanding section 202, the characteristic region detecting section 203, the associating section 206, and the output section 207 have substantially the same functions and operations as the compressed moving image obtaining section 201, the compressed moving image expanding section 202, the characteristic region detecting section 203, the associating section 206, and the output section 207 described with reference to FIGS. 2A to 12. Therefore, the following does not explain those constituents, unless they are different from their counterparts described with reference to FIGS. 2A to 12.

The compression control unit 270 controls the compressing operation by the compressing section 240. The compression control unit 270 supplies information indicating the characteristic regions identified by the characteristic region identifying section 252 to the associating section 206. For example, the compression control unit 270 obtains the characteristic regions identified by the characteristic region identifying section 252, and controls the compressing operation to be performed by the compressing section 240 on the characteristic regions. Specifically speaking, the compression control unit 270 controls the compressing section 240 so as to perform the compressing operation in the following manner.

The image quality control section 280 controls the image qualities of characteristic regions in each of the moving-image-component images generated by the compressed moving image expanding section 202 and the image quality of a non-characteristic region, in accordance with the characteristic amounts of the characteristic regions. The image quality reducing section 281 reduces the image quality of the moving image, and generates a plurality of moving images with predetermined different image qualities. The image quality reducing section 281 supplies the generated moving images with different image qualities to the inter-grade difference compressing sections 282. Specifically speaking, the image quality reducing section 281 generates the moving images with different image qualities by reducing the frame rate of the moving image, or lowering the resolution of the moving-image-component image included in the moving image.

The inter-grade difference compressing sections 282 respectively obtain from the image quality reducing section 281 the moving images of the predetermined different image qualities, and compress the obtained moving images. Here, each inter-grade difference compressing section 282 compresses a moving image having a different image quality. Note that the moving-image-component image included in the moving image supplied to the inter-grade difference compressing section 282a has a lower image quality than the characteristic region images which are the moving-image-component images included in the moving images supplied to the inter-grade difference compressing sections 282b to 282d. Which is to say, the image quality reducing section 281 generates low-image-quality images having a lower image quality than the characteristic region images supplied to the inter-grade difference compressing section 282b to 282d, and supplies the low-image-quality images to the inter-grade difference compressing section 282a.

As described above, the inter-grade difference compressing section 282a obtains from the image quality reducing section 281 the moving-image-component image having a lower resolution than the moving-image-component images received by any of the inter-grade difference compressing sections 282b to 282d, and compresses the obtained moving-image-component image. The inter-grade difference compressing sections 282b to 282d obtain from the image quality reducing section 281 the moving-image-component images and compress the obtained moving-image-component images. Here, the resolutions of the moving-image-component images become higher in the order of the inter-grade difference compressing sections 282b, 282c, and 282d.

The inter-grade difference compressing section 282b expands the moving-image-component image which has been compressed by the inter-grade difference compressing section 282a, and enlarges the resulting moving-image-component image so as to have the same resolution as the moving-image-component image obtained from the image quality reducing section 281. The inter-grade difference compressing section 282b compresses the differential image between the enlarged moving-image-component image and the moving-image-component image obtained from the image quality reducing section 281. Here, the inter-grade difference compressing section 282b generates the differential image which has differential values in the characteristic regions but has no differential values in the non-characteristic region and compresses the generated difference image.

The inter-grade difference compressing section 282c expands the moving-image-component image which has been compressed by the inter-grade difference compressing section 282b, and enlarges the resulting moving-image-component image so as to have the same resolution as the moving-image-component image obtained from the image quality reducing section 281. The inter-grade difference compressing section 282c compresses the differential image between the enlarged moving-image-component image and the moving-image-component image obtained from the image quality reducing section 281. Here, the inter-grade difference compressing section 282c generates the differential image which has differential values in at least some of the characteristic regions but has no differential values in the region other than the above-mentioned some of the characteristic regions and compresses the generated differential image. Here, the above-mentioned some of the characteristic regions are selected in accordance with the characteristic amounts of the characteristic regions.

The inter-grade difference compressing sections 282d expands the moving-image-component image which has been compressed by the inter-grade difference compressing section 282c, and enlarges the resulting moving-image-component image so as to have the same resolution as the moving-image-component image obtained from the image quality control section 280. The inter-grade difference compressing sections 282d compresses the differential image between the enlarged moving-image-component image and the moving-image-component image obtained from the image quality control section 280. Here, the inter-grade difference compressing section 282d generates the differential image which has differential values in at least some of the characteristic regions which are selected in accordance with the characteristic amounts but has no differential values in the region other than the above-mentioned some of the characteristic regions and compresses the generated differential image.

As described above, each of the inter-grade difference compressing sections 282b to 282d produces the differential image by calculating the difference between the moving-image-component image received from the image quality control section 280 or image quality reducing section 281 and the moving-image-component image obtained by enlarging the moving-image-component image having a lower resolution. The associating section 206 associates the compressed moving image data including the moving-image-component images obtained by the compressing operations of the inter-grade difference compressing sections 282a to 282d, with information identifying the characteristic regions. The output section 207 transmits to the image processing apparatus 170 the compressed moving image data which is associated by the associating section 206 with the information identifying the characteristic regions. As a result, the image processing apparatus 120 can provide a moving image which has been scalably compressed and coded in accordance with the characteristic amounts of the characteristic regions.

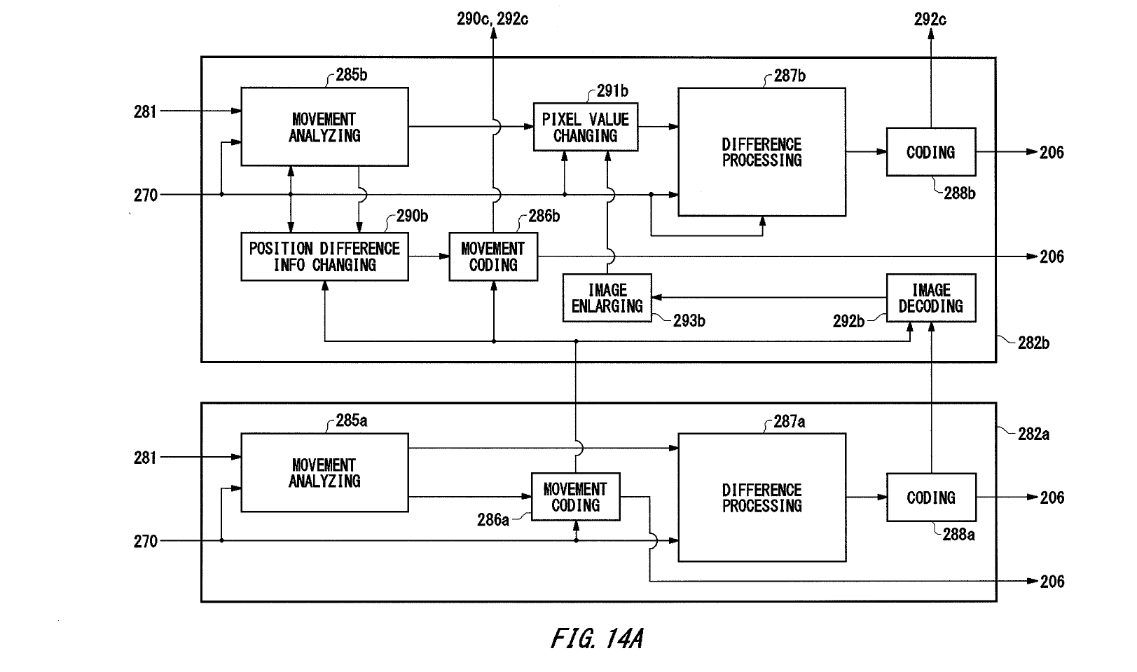

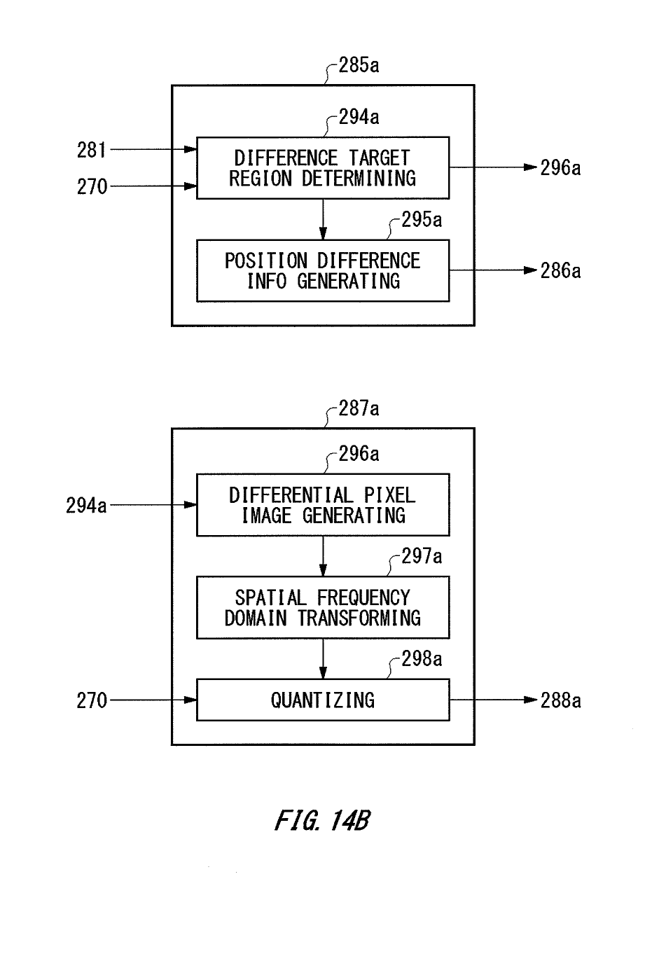

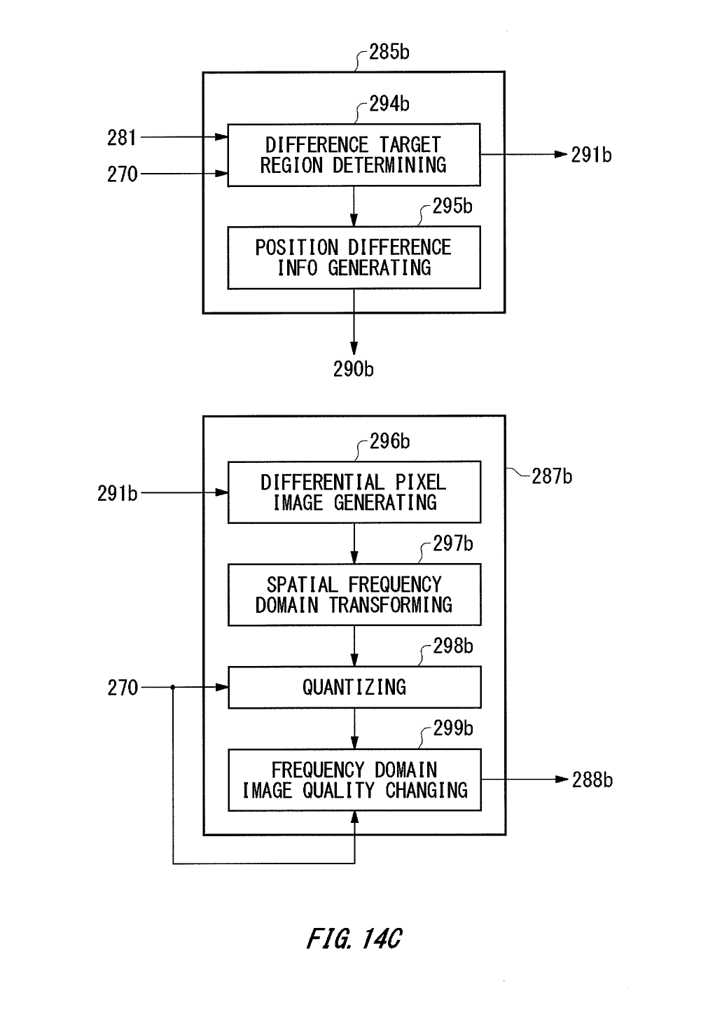

FIG. 14A illustrates exemplary block configurations of the inter-grade difference compressing sections 282a and 282b. FIG. 14B illustrates exemplary block configurations of a movement analyzing section 285a and a difference processing section 287a. FIG. 14C illustrates exemplary block configurations of a movement analyzing section 285b and a difference processing section 287b. The inter-grade difference compressing section 282a includes a movement analyzing section 285a, a movement coding section 286a, a difference processing section 287a, and a coding section 288a. The movement analyzing section 285a includes a difference target region determining section 294a and a position difference information generating section 295a. The difference processing section 287a includes a differential pixel image generating section 296a, a spatial frequency domain transforming section 297a and a quantizing section 298a.

The inter-grade difference compressing section 282b includes a movement analyzing section 285b, a movement coding section 286b, a difference processing section 287b, an image enlarging section 293b, an image decoding section 292b, a pixel value changing section 291b, and a coding section 288b. The movement analyzing section 285b includes a difference target region determining section 294band a position difference information generating section 295b. The difference processing section 287b includes a differential pixel image generating section 296b, a spatial frequency domain transforming section 297b, a quantizing section 298b, and a frequency domain image quality converting section 299b. Note that the inter-grade difference compressing sections 282c and 282d have substantially the same constituents as the inter-grade difference compressing section 282b and thus are not explained herein.

The following describes the functions and operations of the constituents of the inter-grade difference compressing section 282a. The movement analyzing section 285a receives moving-image-component images from the image quality reducing section 281, analyzes movement across a plurality of moving-image-component images based on what is shown by the received moving-image-component images, and refers to the analyzed movement to determine a partial region to be compressed in a moving-image-component image.

Specifically speaking, the difference target region determining section 294a refers to the pixel values of the moving-image-component images in the partial region and, when a moving-image-component image is compressed by calculating its difference from a different moving-image-component image, determines the partial region in the different moving-image-component image that is a difference-target image to be compared to calculate the difference. The difference target region determining section 294a supplies pixel information of the partial region of the moving-image-component image to be compressed and pixel information of the partial region of the difference-target image, to the difference processing section 287a.

The position difference information generating section 295a generates position difference information indicating the difference in position between the partial region to be compressed and the partial region in the difference-target image. Specifically speaking, the position difference information generating section 295a generates a motion vector for use with the motion compensation technique. The position difference information generating section 295a supplies the generated position difference information to the movement coding section 286a.

The movement coding section 286a codes the position difference information supplied from the position difference information generating section 295a, and supplies the coded position difference information to the associating section 206. For example, the movement coding section 286a codes the difference between pieces of position difference information for adjacent partial regions, and supplies the result to the associating section 206.

The difference processing section 287a compresses the image of the partial region to be compressed based on the difference between the pixel information of the partial region to be compressed and the pixel information of the partial region in the difference-target image, which are received from the movement analyzing section 285a. Specifically speaking, the differential pixel image generating section 296a generates a differential pixel image based on the difference between the pixel information of the partial region to be compressed and the pixel information of the partial region in the difference-target image.

The spatial frequency domain transforming section 297a transforms the differential pixel image of each partial region into a spatial frequency domain. Specifically speaking, the spatial frequency domain transforming section 297a transforms the differential pixel image of each partial region into a spatial frequency domain by the discrete cosine transform (DCT). Here, the spatial frequency domain transforming section 297a may transform the differential pixel image of each partial region into a spatial frequency domain by using a variety of frequency transforming techniques including Hadamard transformation and wavelet transformation.

When the movement analyzing section 285a decides that a partial region in a moving-image-component image is not compressed by using its difference from a partial region in a different moving-image-component image, the difference processing section 287a supplies the pixel information of the partial region to be compressed to the spatial frequency domain transforming section 297a. The spatial frequency domain transforming section 297a transforms the pixel information of each partial region into a spatial frequency domain as mentioned above.

The quantizing section 298a quantizes the transform coefficients obtained as a result of the transformation into the spatial frequency region performed by the spatial frequency domain transforming section 297a. The coding section 288a codes the quantized transform coefficients obtained by the quantizing section 298a, to compress the quantized transform coefficients. For example, the coding section 288a codes the quantized transform coefficients obtained by the quantizing section 298a by way of entropy coding such as Huffman coding and arithmetic coding. The coding section 288a supplies the coded moving image to the associating section 206.

The following describes the functions and operations of the constituents of the inter-grade difference compressing section 282b. Here, some of the constituents of the inter-grade difference compressing section 282b are assigned the same reference numerals as the constituents of the inter-grade difference compressing section 282a, and have similar functions and operations to their corresponding constituents of the inter-grade difference compressing section 282a. Therefore, such constituents are not described in the following except for their differences.

For each of the moving-image-component images received from the image quality reducing section 281, the difference target region determining section 294bidentifies a partial region in a different moving-image-component image that is to be compared to calculate its difference from a partial region in the moving-image-component image to be compressed, similarly to the difference target region determining section 294a. As described, the difference target region determining section 294bdetermines, for a partial region in a characteristic region image, a partial region which is included in a characteristic region image generated from a different moving-image-component image and which is to be compared to calculate its difference from the partial region in the characteristic region image. The difference target region determining section 294bsupplies the pixel information of the partial region to be compressed and the pixel information of the partial region in the difference-target image, to the pixel value changing section 291b.

The image decoding section 292b obtains a moving-image-component image from the coding section 288a, and obtains position difference information from the movement coding section 286a. The image decoding section 292b decodes the moving-image-component image obtained from the coding section 288a by means of the position difference information obtained from the movement coding section 286a. The image decoding section 292b may obtain the moving-image-component image which has been quantized by the quantizing section 298a and decode the obtained moving-image-component image, or may obtain the moving-image-component image which has been coded by the coding section 288a and decode the obtained moving-image-component images.

The image enlarging section 293b enlarges the moving-image-component image which has been decoded by the image decoding section 292b, to generate an enlarged image. The pixel value changing section 291b replaces the pixel values of a partial region that is not contained in the characteristic region with the pixel values of a partial region in the enlarged image, without changing the pixel values of a partial region containing the characteristic region, where the both partial regions are determined by the difference target region determining section 294b. In this manner, the pixel value changing section 291b generates characteristic region images in which the pixel values of a non-characteristic region have been replaced by the pixel values of the enlarged images, based on the received moving-image-component images.

The difference processing section 287b receives, from the pixel value changing section 291b, the characteristic region image to be compressed, the image information of the partial region that is a difference target of the partial region contained in the characteristic region image, and the enlarged images. The difference processing section 287b subsequently selects one of the following three coding techniques for each of the partial regions contained in the characteristic region image to be compressed, where the three coding techniques include intra coding, inter coding and inter-grade coding. The intra coding codes the partial region by using the pixel information of the characteristic region image in which the partial region is contained. The inter coding codes the partial region by means of the difference between the partial region and the difference-target partial region contained in a different moving-image-component image. The inter-grade coding codes the partial region by means of the difference between the partial region and the enlarged images. When making the selection, the difference processing section 287b gives priority to a coding method which realizes the smallest code amount. Note that the difference processing section 287b selects the inter-grade coding for the non-characteristic region, since the pixel values in the non-characteristic region are replaced so as to have no differences. Therefore, the following first describes the inter-grade coding, and subsequently explains the inter coding and the intra coding.

When the difference processing section 287b selects the inter-grade coding, the differential pixel image generating section 296b generates a differential pixel image representing a difference in pixel value between the characteristic region image and the enlarged image. Specifically speaking, the differential pixel image generating section 296b generates the differential pixel image based on the difference between the characteristic region image in which the pixel values in the non-characteristic region are replaced and the enlarged image. Since the pixel values in the non-characteristic region of the characteristic region image are replaced with the pixel values of the enlarged image, the differential pixel image generating section 296b can generate a differential pixel image which, in the characteristic region, has differential values representing the difference in pixel value between the characteristic region image and the enlarged image and, in the non-characteristic region, has no such differential values.

When the difference processing section 287b selects the inter coding, the differential pixel image generating section 296b calculates the difference between a characteristic region image generated by the pixel value changing section 291b based on a moving-image-component image and a characteristic region image generated by the pixel value changing section 291b based on a different moving-image-component image. Specifically speaking, the differential pixel image generating section 296b calculates the difference between an image of a partial region contained in the characteristic region and an image of a difference-target partial region which is determined by the difference target region determining section 294bfor the partial region. Since the pixel values in the non-characteristic region in the characteristic region image are replaced with the pixel values of the enlarged image, the differential pixel image generating section 296b can generate a differential pixel image which, in the partial region contained in the characteristic region, has differential values representing the difference in pixel value between the partial region and the partial region determined by the difference target region determining section 294band, in the non-characteristic region, has differential values representing the difference in pixel value between the non-characteristic region and the partial region determined by the difference target region determining section 294b.

When the difference processing section 287b selects the intra coding, the differential pixel image generating section 296b generates a differential pixel image by calculating the difference in pixel value between the image of the partial region contained in each of the characteristic region images and a different region of the characteristic region image, or between the image of the partial region contained in each of the characteristic region images and the same partial region of the characteristic region image.

The spatial frequency domain transforming section 297b transforms the differential pixel image of each partial region into a spatial frequency domain. Specifically speaking, the spatial frequency domain transforming section 297b transforms the differential values represented by the differential pixel image of each partial region into a spatial frequency domain, by using DCT, Hadamard transform, or wavelet transform, similarly to the spatial frequency domain transforming section 297a. The quantizing section 298b quantizes the transform coefficients obtained as a result of the transformation into the spatial frequency domain performed by the spatial frequency domain transforming section 297b, similarly to the quantizing section 298b.

The frequency domain image quality changing section 299b generates a characteristic region difference image by reducing the data amount of the spatial frequency components of at least some partial regions containing the non-characteristic region, from among the spatial frequency components of the respective partial regions which are obtained by the spatial frequency domain transform performed by the spatial frequency domain transforming section 297b. Specifically speaking, the frequency domain image quality changing section 299b reduces the values of the transform coefficients indicating higher frequency components than a predetermined frequency. The frequency domain image quality changing section 299b may set, at zero, the values of the transform coefficients indicating higher frequency components than a predetermined frequency.

As described above, the difference processing section 287b generates a characteristic region difference image which, in the characteristic region, has spatial frequency components obtained by transforming the difference between the characteristic region image and the enlarged image into the spatial frequency domain and, in the non-characteristic region, has spatial frequency components with a reduced data amount. The coding section 288b codes the characteristic region difference image generated by the difference processing section 287b.

Also as described above, the difference processing section 287b generates a characteristic region difference image representing a differential image between the image of the characteristic region in the characteristic region image and the image of the characteristic region in the low-image-quality image. Specifically speaking, the difference processing section 287b generates a characteristic region difference image representing a difference between the image of the characteristic region in the characteristic region image and the image obtained by enlarging the image of the characteristic region in the low-image-quality image.

According to the above description, the pixel value changing section 291b replaces the pixel values of the non-characteristic region with the pixel values of the enlarged image in order that the differential pixel image has the differential values of zero in at least the non-characteristic region, where the non-characteristic region is different from a characteristic region having a predetermined type of character and different from a characteristic region having a certain type of character that is expected to have higher resolution than the characteristic region. However, the pixel value changing section 291b can set the differential values in the differential pixel image at zero by using a different method.

For example, the pixel value changing section 291b may change the pixel values of the non-characteristic region in the moving-image-component image obtained from the image quality reducing section 281 into a predetermined pixel value, and change the pixel values of the same image region in the enlarged image into the predetermined pixel value. This alternative method also produces such an effect that the differential pixel image has the differential values of zero in the non-characteristic region, thereby substantially reducing the information amount of the non-characteristic region.

As explained above, the pixel value changing section 291b generates characteristic region images by replacing the pixel values of the non-characteristic region in a moving-image-component image with a predetermined value and replacing the pixel values of the non-characteristic region in the enlarged image with the predetermined value. The differential pixel image generating section 296b generates a differential pixel image by calculating the difference between the characteristic region image and the enlarged image, in both of which the pixel values have been replaced in the non-characteristic regions.

The pixel value changing section 291b may replace the pixel values of the non-characteristic region of the moving-image-component image obtained from the image quality reducing section 281 with the pixel values of the same region in the image obtained by enlarging the moving-image-component image provided to an inter-grade difference compressing section 282 of a lower grade (for example, the inter-grade difference compressing section 282a). This alternative method also enables the differential pixel image to have the differential values of substantially zero in the non-characteristic region, thereby substantially reducing the information amount of the non-characteristic region.

The position difference information generating section 295b generates position difference information indicating the difference in position of a difference-target partial region contained in the non-characteristic region. Specifically speaking, the position difference information generating section 295b generates position difference information indicating the difference in position between a partial region to be compressed by calculating a difference and a difference-target partial region to be compared to calculate the difference, similarly to the position difference information generating section 295a . Here, the position difference information includes a motion vector for use with the motion compensation.

The position difference information changing section 290b changes the position difference information so that the position difference information indicates that the partial region contained in the non-characteristic region is compared with a partial region in the same position to calculate the difference. Specifically speaking, the position difference information changing section 290b changes the position difference information of the partial region contained in the non-characteristic region into position difference information indicating there is no difference in position. The position difference information changing section 290b obtains the position difference information from the movement coding section 286a, and changes the position difference information of the partial region contained in the non-characteristic region into information indicating that there is no difference in position. Specifically speaking, the position difference information changing section 290b sets the value of the motion vector of the non-characteristic region at zero. For example, the position difference information changing section 290b sets, at zero, the value of the motion vector of the non-characteristic region received from the position difference information generating section 295b and sets, at zero, the value of the motion vector of the non-characteristic region received from the movement coding section 286a.

The movement coding section 286b codes the position difference information. Specifically speaking, the movement coding section 286b codes the difference between pieces of position difference information of adjacent partial regions, similarly to the movement coding section 286a. The movement coding section 286b supplies the coded position difference information to the associating section 206.

In the present embodiment, the position difference information changing section 290 changes the position difference information for the non-characteristic region. The position difference information changing section 290b may change the position difference information for the non-characteristic region by way of the coding format used by the movement coding section 286b. Which is to say, the position difference information changing section 290b may change the position difference information that has been coded by the movement coding section 286, so that the changed position difference information indicates that the partial region contained in the non-characteristic region is compared with a partial region in the same position to calculate a difference.

The coding section 288b may generate coded data that has no difference information in the non-characteristic region. Specifically speaking, the coding section 288b may generate coded data that has no difference information in the partial region contained in the non-characteristic region. The movement coding section 286b may generate coded data that has no position difference information for the partial region contained in the non-characteristic region. As stated, the coding section 288b and the movement coding section 286b generate coded data which indicates that the non-characteristic region shows the same image as the same region in a different moving-image-component image by not having difference information and position difference information. For example, the coding section 288b and the movement coding section 286b may generate coded data including a partial region type, which indicates that the partial region contained in the non-characteristic region shows the same image as the same region in a different moving-image-component image.

For example, the coding section 288b and the movement coding section 286b may generate coded data including a partial region type, which indicates that the partial region contained in the non-characteristic region is coded by using a coding mode that is based on simple inter-frame prediction coding and has no conversion coefficients. For example, the partial region type may correspond to the Non MC Not Coded mode of the MPEG coding technique. As described above, since the coding section 288b and the movement coding section 286b generate coded data without information indicating that the value of the motion vector and the difference information are set at zero, the present embodiment can further reduce the code amount of the coded moving-image-component image. Here, when determining the prediction mode including the above-mentioned coding mode, the inter-grade difference compressing section 282b may select a prediction mode which can minimize rate distortion cost based on the Lagrange's method of undetermined multipliers.

The inter-grade difference compressing sections 282c and 282d each include constituents having the same functions as the constituents of the inter-grade difference compressing section 282b. In the following description, the constituents of the inter-grade difference compressing sections 282c and 282d which have the same names as the corresponding constituents of the inter-grade difference compressing section 282b are assigned the same reference numerals, where the alphabetical letters b, c and d added to the reference numerals represent the belongingness of the respective constituents from among the inter-grade difference compressing sections 282b, 282c and 282d.

For example, the movement analyzing section 285c is one of the constituents of the inter-grade difference compressing section 282c, and the movement analyzing section 285d is one of the constituents of the inter-grade difference compressing section 282d. In the following description, a reference number without an alphabetical letter refers to all of the corresponding constituents of the inter-grade difference compressing sections 282b to 282d. For example, the pixel value changing section 291 denotes the pixel value changing sections 291b to 291d.

The inter-grade difference compressing sections 282c and 282d are different in terms of the operations and functions from the inter-grade difference compressing section 282b in the following aspects. The inter-grade difference compressing sections 282c and 282d obtain moving images of different image qualities from the image quality reducing section 281 than the inter-grade difference compressing section 282b and process the obtained moving images, and the position difference information changing sections 290c and 290d and the image decoding sections 292c and 292d obtain the position difference information and moving-image-component images for use in the differential processing from different inter-grade difference compressing sections 282, which are designed to process moving images of lower image qualities.

More specifically, the position difference information changing section 290c obtains position difference information from the movement coding section 286b, and changes the obtained position difference information. The image decoding section 292c obtains the position difference information from the movement coding section 286b, obtains moving-image-component images from the coding section 288b, and decodes the obtained moving-image-component images by using the obtained position difference information. The position difference information changing section 290d obtains position difference information from the movement coding section 286c, and changes the obtained position difference information. The image decoding section 292d obtains the position difference information from the movement coding section 286c, obtains moving-image-component images from the coding section 288c, and decodes the obtained moving-image-component images by using the obtained position difference information.

The characteristic region detecting section 203 detects a plurality of characteristic regions with different types of characters from the input moving-image-component image. In this case, the image quality reducing section 281 generates a characteristic region image from the input moving-image-component image by reducing the resolution of a characteristic region having a certain type of character, and generates a different characteristic region image having a higher resolution than the above characteristic region image in a characteristic region having a different type of character from the input moving-image-component image. The inter-grade difference compressing sections 282b to 282d are associated with the types of characters in a one-to-one correspondence. Each of the inter-grade difference compressing sections 282b to 282d compresses a characteristic region image in which at least a characteristic region with a predetermined type of character has a different resolution from a non-characteristic region.

Specifically speaking, the inter-grade difference compressing section 282b processes a low-resolution characteristic region image which has the lowest resolution in all of the characteristic regions. The inter-grade difference compressing section 282c processes a medium-resolution characteristic region image which has a higher resolution than the low-resolution characteristic region image in characteristic regions of predetermined character types. The inter-grade difference compressing section 282d processes a high-resolution characteristic region image which has a high resolution in a characteristic region of a different predetermined character type.

As stated, the difference processing section 287 generates a characteristic region difference image which has, in a characteristic region with a certain type of character and a characteristic region with a different type of character, spatial frequency components obtained by transforming the difference between a characteristic region image and an enlarged image into the spatial frequency domain and, in the remaining region, spatial frequency components with a reduced data amount.

As described above, the difference processing section 287 generates a characteristic region difference image which has, in a characteristic region with a certain type of character, spatial frequency components obtained by transforming the difference between a characteristic region image and an enlarged image into the spatial frequency domain and, in the remaining region, has spatial frequency components with a reduced data amount, and generates an inter-characteristic-region difference image which, in a characteristic region with a different type of character, has spatial frequency components obtained by transforming the difference between a different characteristic region image and an image obtained by enlarging the characteristic region in the different characteristic region image into the spatial frequency domain and, in the remaining region, has spatial frequency components with a reduced data amount.

The coding section 288 codes the characteristic region difference image, the inter-characteristic-region difference image, and the low-image-quality image. The associating section 206 associates, with information identifying the characteristic regions, the position difference information coded by the movement coding sections 286a to 286d and the moving-image-component images (for example, the low-image-quality image, the characteristic region difference image, and the inter-characteristic-region difference image) coded by the coding sections 288a to 288d.

As described above, the inter-grade difference compressing section 282a generates a moving-image-component image whose image quality is reduced in the entire region including a characteristic region, in other words, generates a moving-image-component image containing the low spatial frequency components of the input moving-image-component image. The inter-grade difference compressing section 282b generates a moving-image-component image having frequency components higher than the frequency components of the inter-grade difference compressing section 282a and lower than the frequency components of the inter-grade difference compressing section 282c. The inter-grade difference compressing section 282b generates a moving-image-component image in which the differential values representing the difference between the moving-image-component image and the moving-image-component image generated by the inter-grade difference compressing section 282a are reduced in the non-characteristic region.

Similarly, the inter-grade difference compressing section 282c generates a moving-image-component image having frequency components higher than the frequency components of the inter-grade difference compressing section 282b and lower than the frequency components of the inter-grade difference compressing section 282d. The inter-grade difference compressing section 282d generates a moving-image-component image having higher frequency components than the inter-grade difference compressing section 282c. The inter-grade difference compressing sections 282c and 282d generate moving-image-component images in which the differential values representing the respective differences between the moving-image-component images and the moving-image-component images generated by the inter-grade difference compressing sections 282b and 282c in the non-characteristic region.

As described above, each of the inter-grade difference compressing sections 282b, 282c and 282d processes a moving image in which a characteristic region having a predetermined type of character has a higher image quality than the remaining region. Thus, the inter-grade difference compressing sections 282b, 282c and 282d can provide, to outside, moving images whose image qualities are different in accordance with the types of characters. Here, each of the inter-grade difference compressing sections 282b, 282c and 282d can efficiently compress the moving image by compressing the differences between its moving-image-component images and moving-image-component images with a lower image quality which are processed by a different one of the inter-grade difference compressing sections 282b, 282c and 282d.

When detecting the characteristic amount of each characteristic region, the characteristic region detecting section 203 may calculate, for each characteristic region, the degree of reliability indicating how reliable the characteristic region is. Each of the inter-grade difference compressing sections 282b, 282c and 282d compresses the image of the characteristic region whose resolution is adjusted in accordance with the characteristic amount and the degree of reliability of the characteristic region. For example, the image quality reducing section 281 may adjust the resolution of the image of each characteristic region in accordance with the characteristic amount and the degree of reliability of the characteristic region, and supply the adjusted image to the corresponding one of the inter-grade difference compressing sections 282. For example, the image quality reducing section 281 may increase the resolution of the image of each characteristic region image as the degree of reliability decreases, where the adjusted resolution is higher than a predetermined resolution in accordance with the characteristic amount.

As described above, the image processing apparatus 120 performs hierarchical coding by coding the differences between the images of different grades which have different resolutions. As is apparent from this configuration, the compressing method used by the image processing apparatus 120 partly includes the compressing method of H.264/SVC. When expanding such hierarchically-arranged compressed moving images, the image processing apparatus 170 decodes the pieces of moving-image data of the respective grades one by one, to obtain a plurality of moving-image-component images associated with each grade. The image processing apparatus 170 then adds together the region of the obtained moving-image-component images which was coded by using the inter-grade difference and the region of the moving-image-component images associated with a different grade which was compared to calculate the inter-grade difference. In this manner, the image processing apparatus 170 can generate a plurality of moving-image-component images contained in a moving image for each grade.

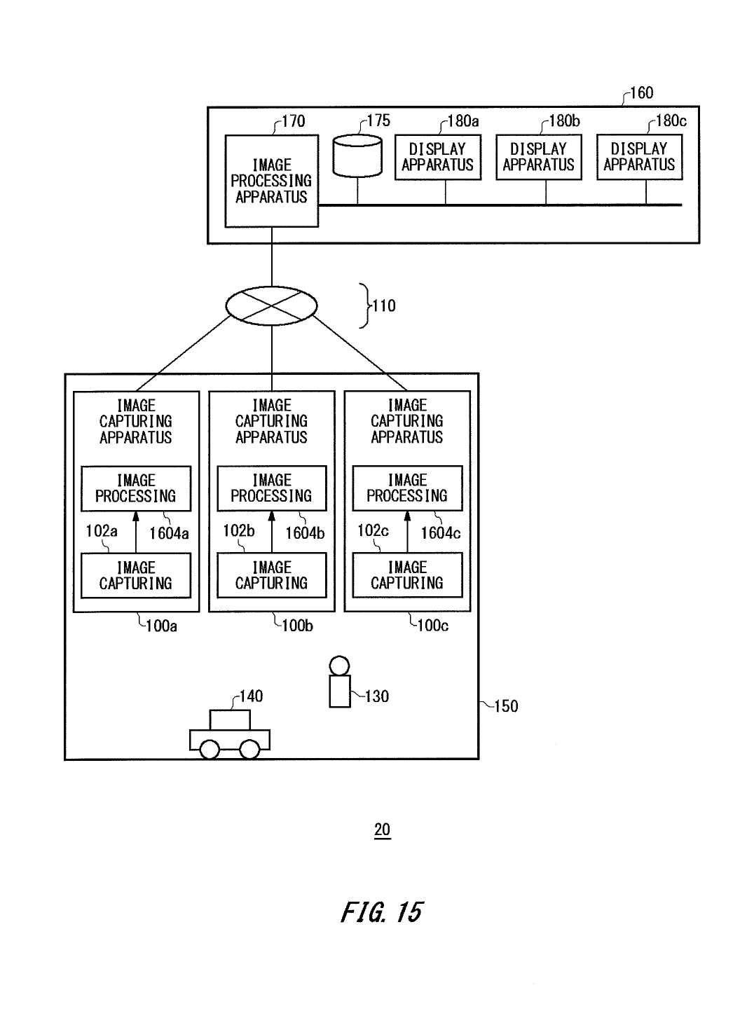

FIG. 15 illustrates an exemplary configuration of an image processing system 20 relating to a different embodiment. The image processing system 20 relating to the present embodiment is configured in the same manner as the image processing system 10 illustrated in FIG. 1, except that the image processing apparatuses 120a to 120c are replaced by image processing sections 1604a to 1604a (hereinafter, collectively referred to as the image processing section 1604) included in the image capturing apparatuses 100a to 100c.

The image processing section 1604 includes the constituents of the image processing apparatus 120 except for the compressed moving image obtaining section 201 and the compressed moving image expanding section 202. The constituents of the image processing section 1604 may have substantially the same functions and operations as the corresponding constituents of the image processing apparatus 120 except that the constituents of the image processing section 1604 process the captured moving image captured by the image capturing section 102, where the constituents of the image processing apparatus 120 process the captured moving image which is obtained by the expanding operation of the compressed moving image expanding section 202. The image processing system 20 having the above-described configuration can produce the same effects as the image processing system 10 as described with reference to FIGS. 1 to 14.

The image processing section 1604 may obtain a captured moving image including a plurality of moving-image-component images in the RAW format from the image capturing section 102. The image processing section 1604 may detect one or more characteristic regions in each of the moving-image-component images in the RAW format. The image processing section 1604 may compress the moving-image-component images in the RAW format included in the obtained captured moving image, without changing the RAW format. Here, the image processing section 1604 can compress the captured moving image by using the compressing methods described in relation to the operations of the image processing apparatus 120 with reference to FIGS. 1 to 14.

The image processing apparatus 170 can obtain the moving-image-component images in the RAW format by expanding the compressed moving image obtained from the image processing section 1604. The image processing apparatus 170 may perform color estimation (coinciding) processing on the moving-image-component images in the RAW format which are obtained by the expansion, for example, on a region to region basis where the regions include the non-characteristic region and the regions containing the characteristic regions. Here, the image processing apparatus 170 may perform more accurate synchronizing operation on the characteristic regions than on the non-characteristic region.

The image processing apparatus 170 may perform super-resolution processing on the images of the characteristic regions which are obtained by synchronizing the moving-image-component images. The super-resolution processing performed by the image processing apparatus 170 can be exemplified by super-resolution processing based on principal component analysis as disclosed in Japanese Patent Application Publication No. 2006-350498, or super-resolution processing based on movement of a subject as disclosed in Japanese Patent Application Publication No. 2004-88615.

Here, the image processing apparatus 170 may perform the super-resolution processing on each of the objects contained in a characteristic region. For example, when a characteristic region contains the image of a person's face, the image processing apparatus 170 may perform the super-resolution processing on each of the face elements (for example, the eyes, the nose, the mouth and the like), which are shown as examples of the objects. In this case, the image processing apparatus 170 stores the learning data of each of the face elements (for example, the eyes, the nose, the mouth and the like), where the learning data is, for example, the model based on the principal component analysis disclosed in Japanese Patent Application Publication No. 2006-350498. The image processing apparatus 170 may perform the super-resolution processing on the image of each of the face elements included in the characteristic region, by using the learning data selected in association with the face element.

As described above, the image processing apparatus 170 can reconstruct the images of the characteristic regions by using the principal component analysis. The image reconstruction by the image processing apparatus 170 and the learning for the image reconstruction may be realized by, other than the principal component analysis (PCA), locality preserving projection (LPP), linear discriminant analysis (LDA), independent component analysis (ICA), multidimensional scaling (MDS), support vector machine (support vector regression), neural network, hidden Markov model, Bayes estimation, maximum a posteriori (MAP) estimation, iterative back projection (IBP), wavelet transform, locally linear embedding (LLE), Markov random field (MRF), and the like.

The learning data may include low frequency components and high frequency components of the image of an object, which are extracted from a large number of sample images of the object, other than the model disclosed in Japanese Patent Application Publication No. 2006-350498. Here, the low frequency components of the image of each of a plurality of objects of different types may be clustered into a plurality of clusters by using the K-means method or other methods. Each cluster may be associated with a representative low frequency component (for example, the value of a barycenter).

The image processing apparatus 170 extracts a low frequency component from an image of an object contained in a characteristic region in a moving-image-component image. The image processing apparatus 170 then identifies a cluster whose representative low frequency component matches the extracted low frequency component, from among the clusters of low frequency components extracted from sample images of an object, the type of which is the same as the type of the extracted object. The image processing apparatus 170 then identifies a cluster of high frequency components associated with the low frequency components included in the identified cluster. In the above manner, the image processing apparatus 170 can identify the cluster of the high frequency components interrelated to the low frequency component extracted from the object contained in the moving-image-component image.

The image processing apparatus 170 may convert the image of the object into a high-image-quality image having a higher image quality, by using a high frequency component representative of the identified cluster of high frequency components. For example, the image processing apparatus 170 may add, to the image of each object, the high frequency component selected in association with the object, with the weight being determined in accordance with the distance from the center of the object to the processing position on the face. Here, the representative high frequency component of each cluster may be generated by using the closed loop training. As described above, the image processing apparatus 170 may select, for each object, desirable learning data from among pieces of learning data generated by learning the object, and use the selected learning data. Therefore, the image processing apparatus 170 may be able to enhance the image quality of the image of the object more accurately. Note that the image processing apparatus 170 can perform the above-described super-resolution processing on the images of the characteristic regions when included in the image processing system 10 described with reference to FIGS. 1 to 14.

According to the super-resolution processing based on the principal component analysis described in Japanese Patent Application Publication No. 2006-350498, an image of an article is expressed by using a principal component vector and a weighting factor. The data amount of the weighting factor and the principal component vector is significantly smaller than the data amount of the pixel data of the image of the article. Hence, when compressing the images of the characteristic regions of the moving-image-component images obtained from the image capturing section 102, the image processing section 1604 may calculate the above-mentioned weighting factors from the images of the articles contained in the characteristic regions. In other words, the image processing section 1604 can compress the images of the articles contained in the characteristic regions, by representing the images with the use of the principal component vectors and the weighting factors. The image processing section 1604 may transmit the principal component vectors and the weighting factors to the image processing apparatus 170.

In this case, the image processing apparatus 170 can reconstruct the images of the articles contained in the characteristic regions by using the principal component vectors and the weighting factors obtained from the image processing section 1604. Here, the image processing section 1604 can also compress the images of the articles contained in the characteristic regions by using models in which articles are expressed with the use of a variety of other character parameters, other than the model based on the principal component analysis disclosed in Japanese Patent Application Publication No. 2006-350498.

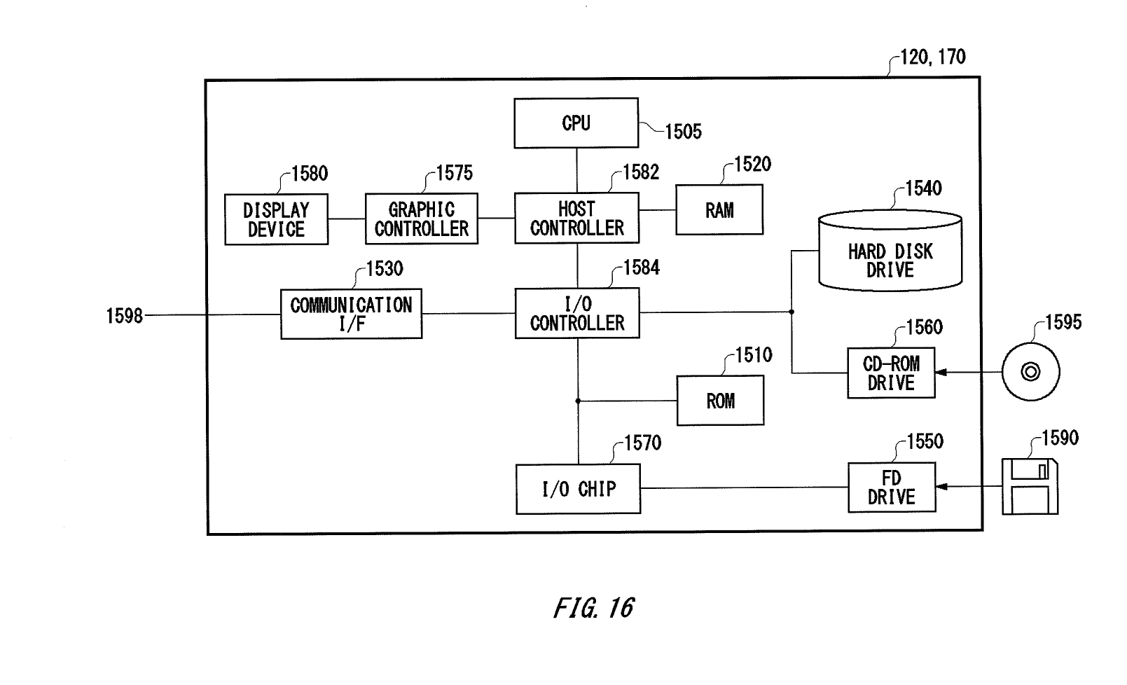

FIG. 16 illustrates an exemplary hardware configuration of the image processing apparatuses 120 and 170. The image processing apparatuses 120 and 170 are each constituted by a CPU surrounding section, an input/output (I/O) section and a legacy I/O section. The CPU surrounding section includes a CPU 1505, a RAM 1520, a graphic controller 1575, and a display device 1580 which are connected to each other by means of a host controller 1582. The I/O section includes a communication interface 1530, a hard disk drive 1540, and a CD-ROM drive 1560 which are connected to the host controller 1582 by means of an I/O controller 1584. The legacy I/O section includes a ROM 1510, a flexible disk drive 1550, and an I/O chip 1570 which are connected to the I/O controller 1584.

The host controller 1582 connects the RAM 1520 with the CPU 1505 and graphic controller 1575 which access the RAM 1520 at a high transfer rate. The CPU 1505 operates in accordance with programs stored on the ROM 1510 and RAM 1520, to control the constituents. The graphic controller 1575 obtains image data which is generated by the CPU 1505 or the like on a frame buffer provided within the RAM 1520, and causes the display device 1580 to display the obtained image data. Alternatively, the graphic controller 1575 may include therein a frame buffer for storing thereon image data generated by the CPU 1505 or the like.

The I/O controller 1584 connects, to the host controller 1582, the hard disk drive 1540, communication interface 1530 and CD-ROM drive 1560 which are I/O devices operating at a relatively high rate. The hard disk drive 1540 stores thereon programs and data to be used by the CPU 1505. The communication interface 1530 couples to the network communication apparatus 1598, to transmit/receive programs or data. The CD-ROM drive 1560 reads programs or data from a CD-ROM 1595, and supplies the read programs or data to the hard disk drive 1540 and communication interface 1530 via the RAM 1520.

The I/O controller 1584 is also connected to the ROM 1510, flexible disk drive 1550 and I/O chip 1570 which are I/O devices operating at a relatively low rate. The ROM 1510 stores thereon a boot program executed by the image processing apparatuses 120 and 170 at the start up, programs dependent on the hardware of the image processing apparatuses 120 and 170, and the like. The flexible disk drive 1550 reads programs or data from a flexible disk 1590, and supplies the read programs or data to the hard disk drive 1540 and communication interface 1530 via the RAM 1520. The I/O chip 1570 is used to connect a variety of I/O devices such as the flexible disk drive 1550 via, for example, a parallel port, a serial port, a keyboard port, a mouse port or the like.

The program to be executed by the CPU 1505 is provided by a user in the state of being stored on a recording medium such as the flexible disk 1590, the CD-ROM 1595, and an IC card. The program may be stored on the recording medium in the state of being compressed or not being compressed. The program is installed from the recording medium onto the hard disk drive 1540, read by the RAM 1520, and executed by the CPU 1505.

The program executed by the CPU 1505 causes the image processing apparatus 120 to function as the compressed moving image obtaining section 201, the compressed moving image expanding section 202, the characteristic region detecting section 203, the image dividing section 204, and the image generating section 205 described with reference to FIGS. 1 to 15. Furthermore, the program executed by the CPU 1505 causes the image processing apparatus 120 to function as the value fixing section 211, the image quality reducing section 221, the coding section 231, the associating section 206, the output section 207 and the compression control unit 270 described with reference to FIGS. 1 to 15.

The program executed by the CPU 1505 also causes the image processing apparatus 120 to function as the motion vector obtaining section 251, the characteristic region identifying section 252 and the inclusion region identifying section 261 described with reference to FIGS. 1 to 15. The program executed by the CPU 1505 also causes the image processing apparatus 170 to function as the compressed moving image obtaining section 301, the association analyzing section 302, the compressed moving image expanding section 311, the combining section 303, and the output section 304 described with reference to FIGS. 1 to 15.

The program mentioned above may be stored on an external recording medium. The recording medium is, for example, an optical recording medium such as DVD and PD, a magnet-optical recording medium such as MD, a tape medium, a semiconductor memory such as an IC card and the like, in addition to the flexible disk 1590 and CD-ROM 1595. The recording medium may be a storage device such as a hard disk or RAM which is provided in a server system connected to a dedicated communication network or the Internet, and the program may be provided to the image processing apparatuses 120 and 170 via the network.

Although some aspects of the present invention have been described by way of exemplary embodiments, it should be understood that those skilled in the art might make many changes and substitutions without departing from the spirit and the scope of the present invention which is defined only by the appended claims.

What is claimed is:

1. An image processing apparatus for processing a moving image including a plurality of moving-image-component images, comprising:
a characteristic region detecting section that detects a characteristic region in one or more of the plurality of moving-image-component images; and
a characteristic region identifying section that identifies a position of the characteristic region in a non-selected image with reference to a position of the characteristic region in a selected image, the selected image being selected from the plurality of moving-image-component images of the moving image, the non-selected image being a different one of the plurality of moving-image-component images than the selected image.

2. The image processing apparatus as set forth in claim 1, wherein
the characteristic region detecting section detects the characteristic region in the selected image that is selected from the plurality of moving-image-component images of the moving image, and
the characteristic region identifying section identifies the position of the characteristic region in the non-selected image which is a not-selected one of the plurality of moving-image-component images in the moving-image, with reference to the position of the characteristic region in the selected image.

3. The image processing apparatus as set forth in claim 2, wherein
the characteristic region identifying section identifies the position of the characteristic region in the non-selected image with reference to a position of the characteristic region in a selected image preceding the non-selected image and a position of the characteristic region in a selected image following the non-selected image.

4. The image processing apparatus as set forth in claim 2, further comprising
a motion vector obtaining section that obtains a motion vector of a subject in the moving image, wherein
the characteristic region identifying section identifies the position of the characteristic region in the non-selected image with reference to the obtained motion vector and the position of the characteristic region in the selected image.

5. The image processing apparatus as set forth in claim 4, further comprising:
a compressed moving image obtaining section that obtains the moving image including the motion vector, the moving image being in a state of compressed; and
a compressed moving image expanding section that expands the moving image obtained by the compressed moving image obtaining section, wherein
the characteristic region detecting section detects the characteristic region in the selected image which is selected from the moving image which has been expanded by the compressed moving image expanding section,
the motion vector obtaining section obtains the motion vector included in the moving image obtained by the compressed moving image obtaining section, and
the characteristic region identifying section identifies the position of the characteristic region in the non-selected image which is a not-selected one of the plurality of moving-image-component images in the moving image that has been expanded by the compressed moving image expanding section, with reference to the obtained motion vector and the position of the characteristic region in the selected image.

6. The image processing apparatus as set forth in claim 5, wherein
the compressed moving image obtaining section obtains an MPEG moving image including the motion vector,
the compressed moving image expanding section expands the MPEG moving image obtained by the compressed moving image obtaining section,
the characteristic region detecting section detects the characteristic region in the selected image included in the expanded MPEG moving image, and
the motion vector obtaining section obtains the motion vector included in the MPEG moving image obtained by the compressed moving image obtaining section.

7. The image processing apparatus as set forth in claim 1, further comprising
a motion vector obtaining section that obtains a motion vector of a subject in the moving image, wherein
the characteristic region identifying section identifies the position of the characteristic region in the non-selected image, with reference to the position of the characteristic region in the selected image and motion vectors associated with more than one of the plurality of moving-image-component images.

8. The image processing apparatus as set forth in claim 7, wherein
the characteristic region identifying section identifies the position of the characteristic region in the non-selected image which is indirectly correlated by way of motion vectors with the characteristic region in the selected image, with reference to the position of the characteristic region in the selected image, a motion vector of the non-selected image, and one or more motion vectors of one or more moving-image-component images which are directly or indirectly correlated with the characteristic region in the selected image and the non-selected image by way of the motion vectors.

9. The image processing apparatus as set forth in claim 8, wherein
the characteristic region identifying section identifies a correlated region in the non-selected image which is indirectly correlated by way of motion vectors with the characteristic region in the selected image, with reference to the position of the characteristic region in the selected image, a motion vector of the non-selected image, and one or more motion vectors of one or more moving-image-component images which are directly or indirectly correlated with the characteristic region in the selected image and the non-selected image by way of the motion vectors, and identifies a region including at least part of the identified correlated region, as the characteristic region in the non-selected image.

10. The image processing apparatus as set forth in claim 9, wherein
the characteristic region identifying section identifies, as the characteristic region, a region including at least one of a characteristic region detected in the non-selected image by the characteristic region detecting section and the correlated region in the non-selected image.

11. The image processing apparatus as set forth in claim 9, wherein
the characteristic region identifying section identifies, as the characteristic region, a region included in both a characteristic region detected in the non-selected image by the characteristic region detecting section and the correlated region in the non-selected image.

12. The image processing apparatus as set forth in claim 9, further comprising
a compressing section that compresses an image of a region other than the characteristic region identified by the characteristic region identifying section at a higher strength than the characteristic region identified by the characteristic region identifying section.

13. The image processing apparatus as set forth in claim 12, wherein
the compressing section compresses an image of a region included in one of a characteristic region detected in the non-selected image by the characteristic region detecting section and the correlated region in the non-selected image, at a higher strength than a region included in both the characteristic region detected in the non-selected image by the characteristic region detecting section and the correlated region in the non-selected image.

14. The image processing apparatus as set forth in claim 9, wherein
when a distance between a position of a characteristic region detected by the characteristic region detecting section in the non-selected image and a position of the correlated region in the non-selected image is longer than a predetermined value, the characteristic region identifying section identifies the correlated region in the non-selected image as a characteristic region containing an object different from an object in the characteristic region detected by the characteristic region detecting section in the non-selected image.

15. The image processing apparatus as set forth in claim 2, further comprising:
an image dividing section that divides each of the selected image and the non-selected image into the characteristic region and a background region other than the characteristic region; and
a coding section that codes an image of the characteristic region and an image of the background region at different strengths from each other.

16. The image processing apparatus as set forth in claim 15, further comprising:
an inclusion region identifying section that identifies an inclusion region including the characteristic region detected in the selected image and the characteristic region identified in the non-selected image; and
a value fixing section that sets, at a fixed value, a pixel value of a region other than the inclusion region in each of the selected image and the non-selected image, wherein
the coding section codes an image of the inclusion region and an image of the region other than the inclusion region at different strengths from each other.

17. An image processing method for processing a moving image including a plurality of moving-image-component images, comprising:
detecting a characteristic region in one or more of the plurality of moving-image-component images; and
identifying a position of the characteristic region in a non-selected image with reference to a position of the characteristic region in a selected image, the selected image being selected from the plurality of moving-image-component images of the moving image, the non-selected image being a different one of the plurality of moving-image-component images than the selected image.

18. A computer readable medium storing thereon a program for use with an image processing apparatus for processing a moving image including a plurality of moving-image-component images, the program causing the image processing apparatus to function as:
a characteristic region detecting section that detects a characteristic region in one or more of the plurality of moving-image-component images; and
a characteristic region identifying section that identifies a position of the characteristic region in a non-selected image with reference to a position of the characteristic region in a selected image, the selected image being selected from the plurality of moving-image-component images of the moving image, the non-selected image being a different one of the plurality of moving-image-component images than the selected image.
